(19) United States
(12) Patent Application Publication
(10) Pub. No.: US 2026/0313106 A1
(43) Pub. Date: Oct. 8, 2026

(54) ADAPTIVE WIENER DEBLOCKING FILTER

(71) Applicant: INTERDIGITAL CE PATENT HOLDINGS, SAS, Paris (FR)

(72) Inventors: Guillaume BOISSON, Pleumeleuc (FR); Philippe BORDES, Laille (FR); Edouard FRANCOIS, Bourg des Comptes (FR); Frederic LEFEBVRE, Rennes (FR); Franck GALPIN, Thorigne-Fouillard (FR)

(21) Appl. No.: 19/479,068

(22) PCT Filed: Apr. 17, 2024
(86) PCT No.: PCT/EP2024/060332

§ 371 Date: Oct. 27, 2025

(30) Foreign Application Priority Data
Apr. 27, 2023 (EP) 23315121.6

(51) Int. Cl. H04N 19/117; H04N 19/176; H04N 19/82

(52) U.S. Cl. CPC H04N 19/117; H04N 19/176; H04N 19/82

(57) ABSTRACT

In-loop filters are commonly used to filter reconstructed video paths within a digital video encoder and decoder. Commonly used filters are deblocking filters and adaptive loop filters. Embodiments provide filter classification techniques for determination of such in-loop filters with adaptability to depend on criteria comprising spatial distance from a block edge, features across block edges, selection of samples to be filtered and filter size or shape. In one embodiment, deblocking characteristics are combined with adaptive loop filters in one filtering step.

### CROSS REFERENCE TO RELATED APPLICATION

This application claims the benefit of European Serial No. 23315121.6, filed Apr. 27, 2023, which is incorporated by reference herein in its entirety.

### FIELD OF THE INVENTION

At least one of the present embodiments generally relates to a method or an apparatus for video encoding or decoding, compression, or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY OF THE INVENTION

At least one of the present embodiments generally relates to a method or an apparatus for video encoding or decoding, and more particularly, to a method or an apparatus for improving the coding efficiency through adaptive in-loop filtering.

According to a first aspect, there is provided a method. The method comprises steps for determining at least one in-loop filter for a video block based on a classification; filtering a reconstructed version of said video block with said determined at least one in-loop filter; signaling said determined at least one in-loop filter; and, encoding the video block using the filtered reconstructed video block

According to a second aspect, there is provided another method. The method comprises steps for deriving a classification for a video block; determining at least one in-loop filter for the video block based on the classification; filtering a reconstructed version of said video block with said determined at least one in-loop filter; and, decoding the video block using the filtered reconstructed video block.

According to another aspect, there is provided an apparatus. The apparatus comprises a processor. The processor can be configured to encode a block of a video or decode data by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates horizontal and vertical block boundaries on an 8×8 grid.

FIG. 2 illustrates an overview of HEVC deblocking decision workflow.

FIG. 3 illustrates sample position of p_{i,k} and q_{i,k} in the case of horizontal and vertical block boundaries.

FIG. 4 illustrates decisions for HEVC normal deblocking mode.

FIG. 5 illustrates four-sample long vertical boundary segment formed by blocks P and Q with VVC deblocking decisions based on lines 0 and 3.

FIG. 6 illustrates vertical and horizontal block boundaries on the 4×4 grid, 32×32 CU with Pus on 8×8 grid, and vertical boundary that may require long-tap deblocking.

FIG. 7 illustrates deblocking filtering (DBFV and DBFH) combined with SAOH and SAOV.

FIG. 8 illustrates ALF filter shapes: left: 5×5 diamond for chroma; right: 7×7 diamond for luma.

FIG. 9 illustrates subsampled Laplacian calculation.

FIG. 10 illustrates ALF process in ECM-3; F0 and F1 are pre-learned filters trained on classifiers C0 and C1, respectively; F2 signaled and uses either classifier C0 or C1.

FIG. 11 illustrates filter shape of signaled filter F2 in ECM-7.0.

FIG. 12 illustrates regular block grid (gray dotted lines) and shifted deblocking grid (solid black line).

FIG. 13 illustrates deblocking range examples (8×8 grid), where only gray samples are filter; samples in white are excluded from deblocking process.

FIG. 14 illustrates examples of spatial classification in the case of a 4×4 grid (left) and of an 8×8 grid (right).

FIG. 15 illustrates symmetries in a quadrant of the deblocking grid.

FIG. 16 illustrates examples of filter shapes (cross, diamond and square) of different sizes, where current to-be-filter sample is depicted in dark gray.

FIG. 17 illustrates examples of off-centered deblocking filter shapes for the top-left quadrant where current to-be-filtered sample is depicted in dark gray.

FIG. 18 illustrates two examples of spatially dependent filter sets (8×8 grid); (a) set of 16 square filters for top-left quadrant; (b) set of 16 cross-shaped filters for top-left quadrant.

FIG. 19 illustrates examples of 1D filter shapes; top row: Horizontal filters (bF_{H}≠0 and bF_{V}=0); Bottom row: Vertical filters (bF_{H}=0 and bF_{V}≠0).

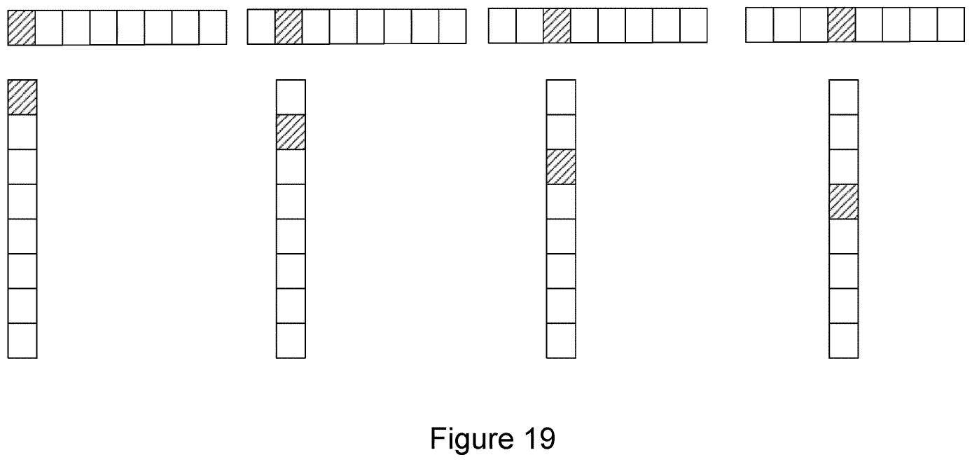

FIG. 20 illustrates one embodiment where modified ALF substitutes to legacy DBF.

FIG. 21 illustrates one embodiment of local deblocking control at encoder side.

FIG. 22 illustrates an example class merging algorithm.

FIG. 23 illustrates an embodiment of a first method under the described aspects.

FIG. 24 illustrates an embodiment of a second method under the described aspects.

FIG. 25 illustrates one embodiment of an apparatus under the described aspects.

FIG. 26 illustrates a standard, generic, video compression scheme.

FIG. 27 illustrates a standard, generic, video decompression scheme.

FIG. 28 illustrates a processor-based system for encoding/decoding under the general described aspects.

### DETAILED DESCRIPTION

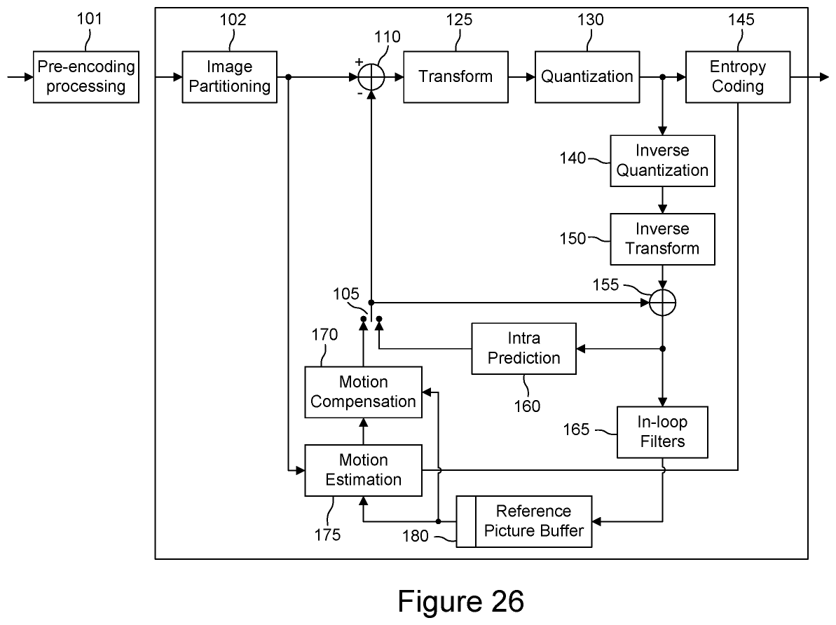

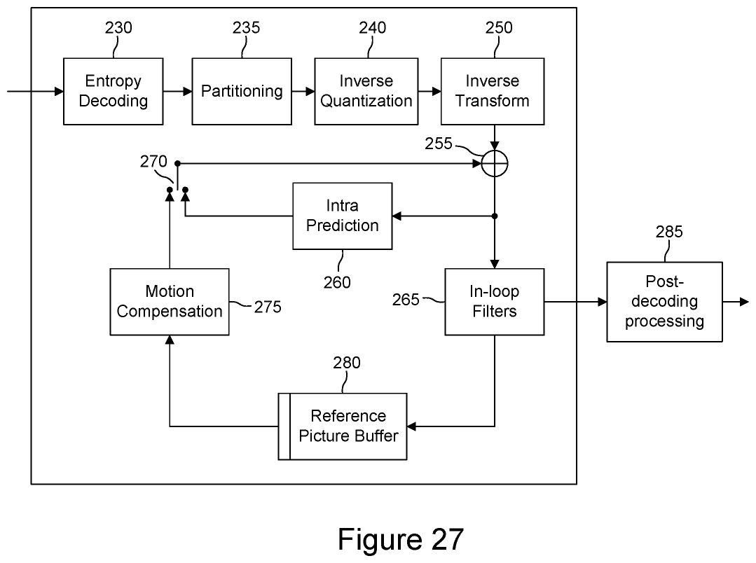

In-loop filters (265) are applied to the reconstructed picture in an encoder or a decoder to perform, for example, deblocking/SAO (Sample Adaptive Offset)/ALF (Adaptive Loop Filter) filtering to reduce encoding artifacts. The described embodiments relate to in-loop filters, corresponding to steps 265 at encoder side in FIGS. 26 and 365 at decoder side in FIG. 27. In these embodiments, it is proposed to derive optimal deblocking filters in terms of mean squared error (MSE). In an embodiment, optimal deblocking filters are pre-learned offline on a training dataset and hard-coded both in encoder and decoder. In another embodiment, deblocking filters are derived at encoding time based on current tile/slice/frame statistics and signaled in the bitstream.

In a block-based video codec, such as HEVC and VVC, discontinuities can appear at the transform and prediction block boundaries. These discontinuities can lead to visual artifacts that are referred to as blocking artifacts. Removing or lessening these artifacts is referred to as deblocking, for instance using deblocking filters (DBF).

A deblocking filter aims to achieve a smooth transition across the block boundaries while avoiding removal of natural edges. As explained in previous section, DBFs in HEVC and VVC are in-loop filters, that is, filters implemented within the reconstruction loop both at encoder and decoder sides. In HEVC and VVC, DBFs are driven by signal characteristics across block boundaries, together with coding information such as partitioning and prediction modes in such a way that no information/parameter is signaled.

On the other hand, Adaptive Loop Filtering (ALF) is another in-loop filter that aims to enhance reconstructed pictures with respect to original pictures in the sense of MSE. At encoder side, ALF filters are optimized based on current tile/slice/picture statistics, then signaled in the bitstream. In addition to signaled ALF filters, pre-trained filters are available (hard-coded) both at encoder and decoder sides. Those pre-trained filters have been learned offline on a training set. Note that Luma ALF filters rely on a local classification.

The next subsections provide more details about DBF and ALF, respectively.

### Deblocking Filters (DBF)

As already mentioned, block-based coding creates discontinuities at block boundaries.

Because excessive filtering may lead to unnecessary smoothing of the picture details, whereas lack of filtering may leave noticeable blocking artifacts, prior art addresses mainly how to decide whether to filter a particular block boundary or not, and how to decide on the filtering strength to be applied.

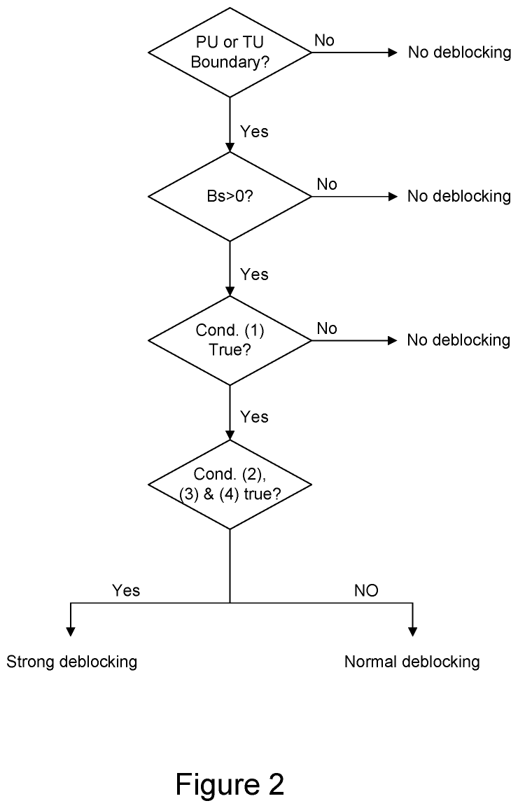

In current deblocking solutions, those decisions basically depend on the characteristics of the reconstructed pixels values on both sides of that block boundary, and on the coded parameters indicating whether it is likely that a blocking artifact has been created by the coding process. An overview of the deblocking process in HEVC is depicted on FIG. 2. Further details on the DBF implementations in HEVC and VVC can be found in the following subsections.

### DBF in HEVC

NB: A thorough description of HEVC DBF can be found in [Norkin2012]. Key points and contributions are recapped below.

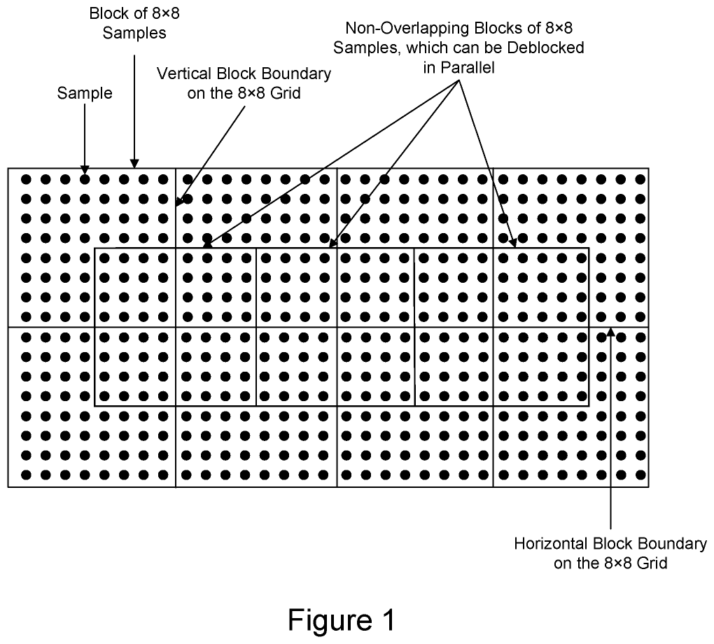

In HEVC, filtering decisions are made separately for each boundary of four-sample length that lies on the grid dividing the picture into blocks of 8×8 samples (see FIG. 1). Only boundaries which are either Prediction Unit (PU) or Transform Unit (PU) boundaries are subject to deblocking.

Deblocking is performed on a four-sample part of a block boundary when all of the following criteria are met: the block boundary is a PU or TU boundary, the boundary strength Bs (see definition in next subsection) is greater than zero, and variation of signal on both sides of the boundary is below a specified threshold.

When certain additional conditions hold, a strong filter is applied instead of the normal deblocking filter.

The whole decision workflow is depicted in FIG. 2. The following subsections provide more detailed explanations on the different conditions tested, as well as specific deblocking implementations in the different modes.

### Boundary Strength (Bs) and Edge-Level Adaptability

The boundary strength (Bs) can take one of the following three possible values: 0, 1, and 2. The definition of Bs is shown in Table 1.

TABLE 1
Definition of Bs values for the boundary
between two neighboring Luma blocks.

| Conditions | Bs |
|---|---|
| At least one of the blocks is intra | 2 |
| At least one of the blocks has non-zero coded residual | 1 |
| coefficient and boundary is a transform boundary | |
| Absolute differences between corresponding spatial | 1 |
| motion vector components of the two blocks | |
| are >=1 in units of integer pixels | |
| Motion-compensated prediction for the two blocks refers | 1 |
| to different reference pictures or the number of | |
| motion vectors is different for the two blocks | |
| Otherwise | 0 |

For Luma, only block boundaries with Bs values equal to 1 or 2 are filtered. For Chroma, only boundary with Bs equal to 2 are filtered.

### Local Adaptivity and Filtering Decisions

If Bs is greater than zero, additional conditions are checked for Luma to determine whether the deblocking filtering should be applied to the block boundary or not.

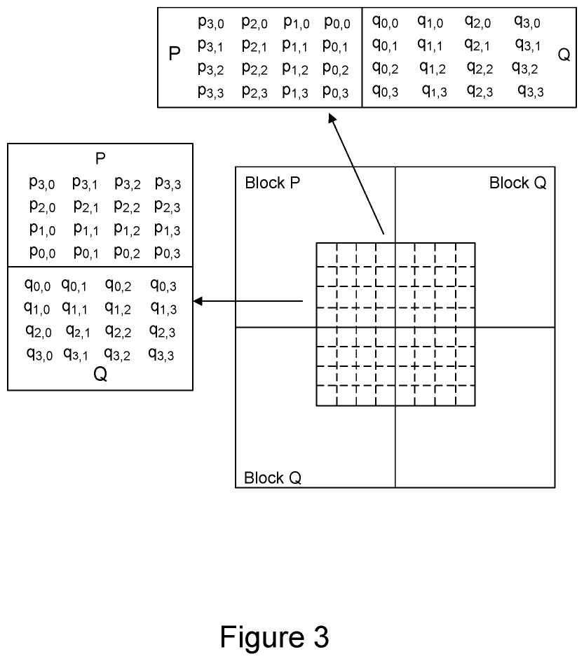

The FIG. 3 depicts four-pixel long horizontal and vertical boundaries on the 8×8 grid.

For each block boundary of four-sample length on the 8×8 sample grid that satisfies the conditions described above in the boundary strength section, the following condition is checked to decide whether the deblocking filtering is applied:

$$\vert {p}_{2 , 0} - 2 {p}_{1 , 0} + {p}_{0 , 0} \vert + \vert {p}_{2 , 3} - 2 {p}_{1 , 3} + {p}_{0 , 3} \vert + \vert {q}_{2 , 0} - 2 {q}_{1 , 0} + {q}_{0 , 0} \vert + \vert {q}_{2 , 3} - 2 {q}_{1 , 3} + {q}_{0 , 3} \vert > β \qquad ( 1 )$$

Where threshold β depends on the quantization parameter (QP) as a monotonically non-decreasing function.

Equation (1) evaluates how much signal on both sides of the block boundary deviates from a straight line (constant level or ramp). Only the first and fourth rows/columns of the block boundary are evaluated to reduce complexity.

### Normal and Strong Deblocking Modes

For block boundaries with an associate Bs greater than zero and for which (1) holds, deblocking filtering is performed. There are two deblocking modes in HEVC, namely the normal deblocking mode and the strong deblocking mode.

Whether to apply strong or normal deblocking is also determined based on local signal characteristics, evaluated on the first and fourth rows/columns (respectively i=0 and i=3) of the four-sample length block boundary.

$$\vert {p}_{2 , i} - 2 {p}_{1 , i} + {p}_{0 , i} \vert + \vert {q}_{2 , i} - 2 {q}_{1 , i} + {q}_{0 , i} \vert < β / 8 \qquad ( 2 )$$

$$\vert {p}_{3 , i} - {p}_{0 , i} \vert + \vert {q}_{0 , i} - {q}_{3 , i} \vert < β / 8 \qquad ( 3 )$$

$$\vert {p}_{0. i} - {q}_{0 , i} \vert < 2.5 \times {t}_{C} \qquad ( 4 )$$

The threshold parameter t_{c} also depends on QP as another monotonically non-decreasing function.

If (2), (3), and (4) hold for both lines #0 and #3, then strong filtering is applied to the block boundary. Otherwise, normal filtering is applied.

Condition (2) checks that there is a low spatial activity on the side of block boundary (like (1) but using a lower threshold). Condition (3) checks that the signal on the block boundaries is flat. Condition (4) checks that the difference in intensities of samples on two sides of the block boundary does not exceed the threshold.

### Further Decisions in Normal Deblocking Mode

Normal filtering has two modes differing in the number of pixels being modified on each side of the block boundary.

Which of the two modes is selected for each boundary based on the following two conditions:

$$\vert {p}_{2 , 0} - 2 {p}_{1 , 0} + {p}_{0 , 0} \vert + \vert {p}_{2 , 3} - 2 {p}_{1 , 3} + {p}_{0 , 3} \vert < 3 β / 16 \qquad ( 5 )$$

$$\vert {q}_{2 , 0} - 2 {q}_{1 , 0} + {q}_{0 , 0} \vert + \vert {q}_{2 , 3} - 2 {q}_{1 , 3} + {q}_{0 , 3} \vert < 3 β / 16 \qquad ( 6 )$$

If (5) is true, the two nearest pixels to the block boundary can be modified in block P. Otherwise, only the nearest pixel in block P can be modified.

Similarly, if (6) holds, the two nearest pixels to the block boundary can be modified in block Q. Otherwise, only the nearest pixel can be modified.

Note that the values of the thresholds used in (5) and (6) are lower than in (1) but higher than in (3). This means that the longer filtering is allowed for the block boundaries that have lower spatial activity on the sides of the boundaries.

### Deblocking Operations

### Normal Filtering Mode

In the normal filtering mode, filtering operations are applied to each of the four lines of an edge segment lying on the 8×8 block boundary grid. In the following, the second index is omitted for brevity.

The filtered pixel values

$${p}_{0}^{′} and {q}_{0}^{′}$$

are computed as follows:

$${p}_{0}^{′} = {p}_{0} + {Δ}_{0} \qquad ( 7 )$$

$${q}_{0}^{′} = {q}_{0} - {Δ}_{0} \qquad ( 8 )$$

Where the value of Δ₀ is obtained by clipping of δ₀:

$${δ}_{0} = ( 9 \times ( {q}_{0} - {p}_{0} ) - 3 \times ( {q}_{1} - {p}_{1} ) + 8 ) ≫ 4 \qquad ( 9 )$$

That clipping operation, like every clipping in the following, is QP-dependent.

Note that the offset value δ₀ is zero if the signal across the block boundary forms a ramp.

Furthermore, the deblocking filtering is applied to the row or column of samples across the block boundary if and only if the following expression holds:

$$\vert {δ}_{0} \vert < 10 \times {t}_{C} \qquad ( 10 )$$

If this condition does not hold, it is likely that the change of the signal on both sides of the block boundary is caused by a natural edge and not by a blocking artifact.

If (5) is true, the modified value

$${p}_{1}^{′}$$

in each row/column across the block boundary is obtained by:

$${p}_{1}^{′} = {p}_{1} + {Δ}_{{p}_{1}} \qquad ( 11 )$$

Similarly, if (6) is true, then

$${q}_{1}^{′}$$

is calculated as:

$${q}_{1}^{′} = {q}_{1} + {Δ}_{{q}_{1}} \qquad ( 12 )$$

where the offset values Δₚ₁ and Δ_{q1} are obtained by clipping the corresponding δₚ_{₁} and δ_{q}_{₁}, which are calculated as:

$${δ}_{{p}_{1}} = ( ( ( {p}_{2} + {p}_{0} + 1 ) ≫ 1 ) - {p}_{1} + {Δ}_{0} ) ≫ 1 \qquad ( 13 )$$

$${δ}_{{q}_{1}} = ( ( ( {q}_{2} + {q}_{0} + 1 ) ≫ 1 ) - {q}_{1} + {Δ}_{0} ) ≫ 1 \qquad ( 14 )$$

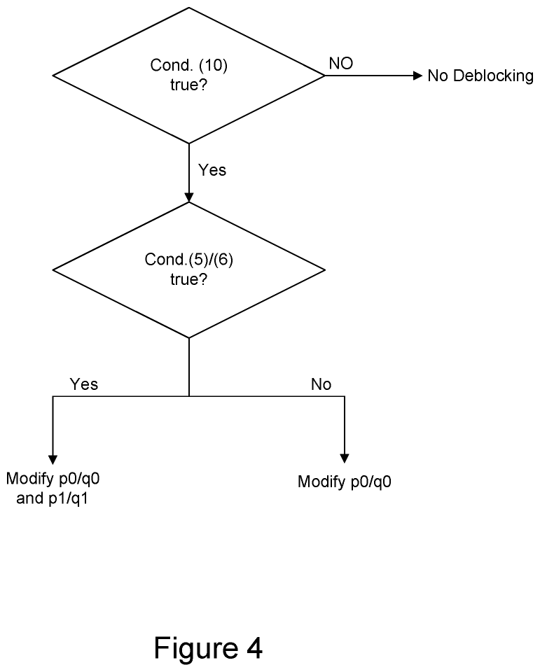

The sequence of filtering in normal deblocking mode is summarized in FIG. 4.

### Strong Filtering Mode

In HEVC, the strong deblocking mode affects more pixels on each side of the block boundary. The offset values Δ₀ₛ, Δ₁ₛ, and Δ₂ₛ are added to pixels p₀, p₁, and p₂, respectively, after clipping of the following δ₀ₛ, δ₁ₛ, and δ₂ₛ values:

$${δ}_{0 s} = ( {p}_{2} + 2 {p}_{1} - 6 {p}_{0} + 2 {q}_{0} + {q}_{1} + 4 ) ≫ 3 \qquad ( 15 )$$

$${δ}_{1 s} = ( {p}_{2} - 3 {p}_{1} + {p}_{0} + {q}_{0} + 2 ) ≫ 2 \qquad ( 16 )$$

$${δ}_{2 s} = ( 2 {p}_{3} - 5 {p}_{2} + {p}_{1} + {p}_{0} + {q}_{0} + 4 ) ≫ 3 \qquad ( 17 )$$

The offset values for modifications of pixels q₀, q₁, and q₂ are obtained by exchanging p with q in (15), (16), and (17).

### Chroma Deblocking

As mentioned previously in discussing boundary strength, chroma deblocking is only performed when Bs is equal to two. In this case, no further deblocking decisions are done. Only pixels p₀ and q₀ are modified as in (7) and (8). The deblocking is performed with the Δ_{c} value, which is obtained by clipping the following δ_{c} offset value:

$${δ}_{c} = ( ( ( {p}_{0} - {q}_{0} ) ≪ 2 ) + {p}_{1} - {q}_{1} + 4 ) ≫ 3 \qquad ( 18 )$$

### DBF in VVC

The VVC DBF is largely based on the HEVC design. VVC essentially allows larger blocks than HEVC. The DBF in VVC basically extends HEVC DBF design to address the artifacts remaining in large smooth areas. Main contributions are briefly described below. The reader can refer to [JVET-T2002] for further details.

### Luma Deblocking

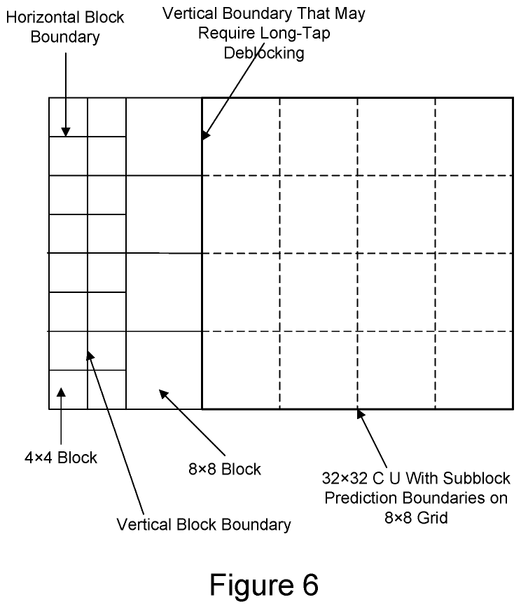

Due to flexible block sizes in VVC, the luma deblocking is applied on a 4×4 sample grid for boundaries between CUs and TUs, and on an 8×8 grid for boundaries between PUs inside CUs, as shown in FIG. 6.

### Filtering Decisions

Before deriving Bs and performing filtering decisions based on spatial activity, VVC DBF decides whether to use long-tap filters and determine appropriate filter lengths. This new step is carried out to ensure that non spatial dependency exists with the adjacent vertical or horizontal block boundaries.

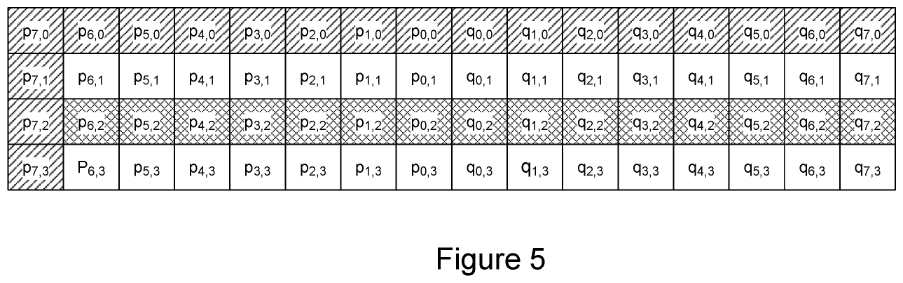

The deblocking length is defined as the number of samples to be filtered for each line for adjacent blocks P and Q (see FIG. 5). The deblocking length of P and Q is denoted as S_{P} and S_{Q}, respectively. The number of samples used for filtering decisions and filtering operations are (S_{P}+1) and (S_{Q}+1). The value of S_{P} and S_{Q} depends on the size of the block side orthogonal to block boundary for block P and Q, respectively. They can be set to 7, 5, 3 and 1 for CU/TU boundaries, and to 3, 2, and 1 for PU boundaries inside a CU. More details are to be found in [JVET-T2002] for the specific conditions at stake.

Note that these values can be reduced further in the subsequent steps of filtering decisions.

After determining the deblocking filter lengths, the boundary strength bS is derived. Compared to HEVC, bS derivation is modified to accommodate new VVC coding tools, such as block-level differential pulse code modulation (BDPCM), combined intra-inter prediction (CIIP), intra block copy (IBC), high motion vector accuracy, etc. Specific bS adaptations are to be found in [JVET-T2002].

In a next step, decisions based on spatial activity are made for the cases of non-zero bS. If the deblocking filter length is larger than 3 on at least one side, the spatial activity decision for the long-tap deblocking filter applies. Otherwise, the decision process for short-tap deblocking filter applies. In both cases, the decision process is similar to that of HEVC, except that further thresholds are introduced that in fine still depend on the QP.

### Filtering Operations

The short-tap deblocking filters are almost identical to the HEVC deblocking filters, the only difference consisting in the introduction of position-dependent clipping to control the differences between filtered values and the sample values before filtering.

The long-tap deblocking filter is designed to preserve inclined surfaces and linear signals across the block boundaries.

### Chroma Deblocking

The Chroma deblocking is performed on an 8×8 sample grid on boundaries of both CUs and TUs. Compared to Luma, deblocking lengths are limited to 3+3, 1+3 or 1+1.

Minor bS adaptations are introduced to account for new VVC coding modes, such as BDPCM and CIIP.

### Non-Standardized Deblocking Solutions

Deblocking filter using adaptive weighting factors [JCTVC-H0148]

In [JCTVC-H0148], Panasonic proposed to modify the deblocking equation (11) in the Luma case with the introduction of a weighting factor α:

$${s}_{k}^{″} = {s}_{k}^{′} + a \times {Δ}_{k} \qquad ( 19 )$$

The optimal weighting factor α is determined on a slice basis and signaled on 6 bits in the slice header. In their implementation, the value of a is determined by minimizing the MSE for a subset of samples that are heuristically identified as subjectively important.

Pre-Sample Adaptive Offset filter [JVET-Q0434]

In [JVET-Q0434], HHI proposed an additional in-loop filter which operated jointly with DBF. This new filter adjusts Luma samples values after the application of DBF, by adding an offset similarly to Sample-Adaptive Offset (SAO). Only samples affected by DBF are processed.

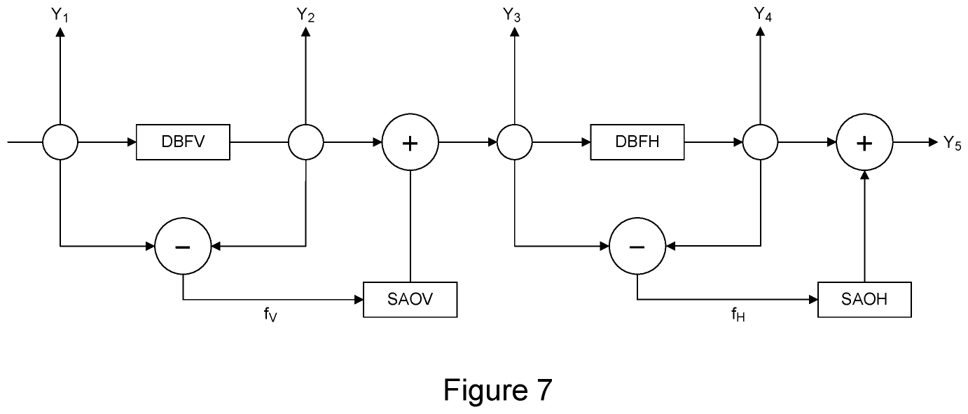

Specifically, two SAO-like filtering SAOV and SAOH are applied for vertical and horizontal DBF, respectively (see FIG. 7).

SAOV (respectively SAOH) involves a classification based on sample-wise difference between sample value before and after DBFV (respectively DBFH) that derives from a predetermined threshold T.

Let f_{V}(i)=Y₁(i)−Y₂(i) denote the classification for SAOV. The corresponding two classes considered are {i∈I: f_{V}(i)>T} and {i∈I: f_{V}(i)<−T}.

Similarly, if we denote f_{H}(i)=Y₃(i)−Y₄(i) denote the classification for SAOH, the corresponding two classes considered are {i∈I:f_{H}(i)>T} and {i∈I:f_{H}(i)<−T}.

Eventually, the pre-Sample Adaptive Offset is conducted as follows:

$$SAOV \text{:} {Y}_{3} ( i ) = {Y}_{2} ( i ) + {d}_{1} \times ( {f}_{V} ( i ) > T ? 1 : 0 ) - {d}_{2} \times ( {f}_{V} ( i ) < - T ? 1 : 0 )$$

$$SAOH \text{:} {Y}_{5} ( i ) = {Y}_{4} ( i ) + {d}_{3} \times ( {f}_{H} ( i ) > T ? 1 : 0 ) - {d}_{4} \times ( {f}_{H} ( i ) < - T ? 1 : 0 )$$

Vertical offset coefficients d₁ and d₂ are calculated at encoder so that the MSE between output picture Y₃ and the original picture is minimized, in a SAO-like way. Similarly, horizontal offset coefficients d₃ and d₄ are calculated to minimize the distortions of output picture Y₅.

Finally offset coefficients (d₁, d₂, d₃, d₄) are signaled for each channel type, together with enabling flags, at slice-level or CTU-level.

### Adaptive Loop Filter (ALF)

As already mentioned, ALF is based on adaptive filters, which are typically applied to reduce the MSE between the original and the reconstructed samples using Wiener-based filtering. In WC, ALF is the last post-filter applied to the output of SAO.

### ALF in WC

A thorough description of WC ALF can be found in [Karczewicz2021]. The sequel is largely based on that article to recap ALF main features.

In WC, ALF includes a classification of non-overlapping 4×4 blocks based on their local sample gradients. For each class, a specific filter is applied among the different filters signaled in the bitstreams. Based on this classification, geometric transformation of coefficients within filter shape, such as 90-degree rotation, diagonal or vertical flip, can also be applied.

### Filter Shape

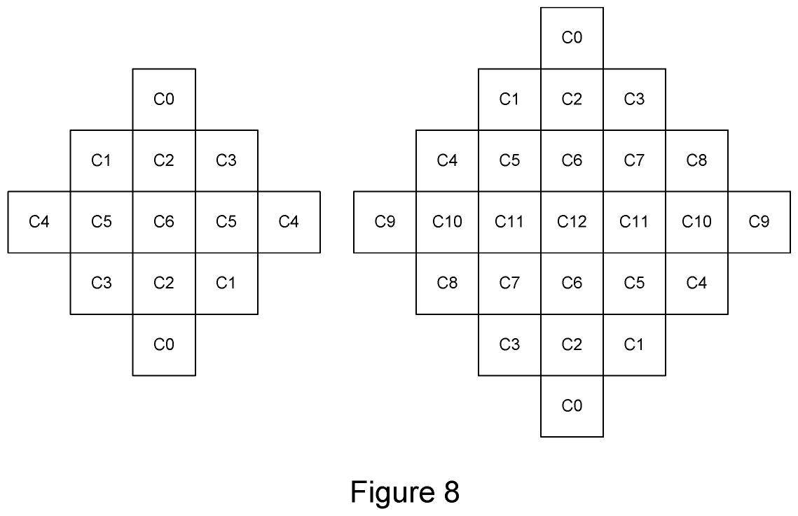

In WC, two filter shapes, 7×7 diamond shape and 5×5 diamond shape, are used for Luma and Chroma components, respectively, as shown in FIG. 8. Each square corresponds to a Luma or a Chroma sample, and the center square denotes the current to-be-filtered sample. To reduce
the signaling overhead and the number of multiplications, the filter coefficients use point-symmetry.

Each integer filter coefficient ci is represented with 7-bit fractional precision. In addition, to preserve DC neutrality, the sum of coefficients of one filter must be equal to 128=1<<7.

$$2 ( {\sum }_{i = 0}^{N - 2} {c}_{i} ) + {c}_{N - 1} = 128 \qquad ( 20 )$$

NB: In Equation (20), the number of coefficients N is equal to 13 and 7 for 7×7 and 5×5 filter shape, respectively.

### Linear Filtering

Because of point-symmetry and DC neutrality, a filtered sample value R̅(x, y) is obtained by adding to the reconstructed sample R(x,y) a weighted sum of the differences between the to-be-filtered sample R(x,y) and its neighboring samples:

$$\overline{R} ( x , y ) = R ( x , y ) + ( [ {\sum }_{i = 0}^{N - 2} {c}_{i} \times ( Δ {R}_{i}^{+} + Δ {R}_{i}^{-} ) ] + 64 ) ≫ 7 \qquad ( 21 )$$

$$With :$$

$$Δ {R}_{i}^{+} = R ( x + {x}_{i} , y + {y}_{i} ) - R ( x , y ) \qquad ( 22 )$$

$$Δ {R}_{i}^{-} = R ( x - {x}_{i} , y - {y}_{i} ) - R ( x , y )$$

Where (x+xᵢ, y+yᵢ) and (x−xᵢ, y−yᵢ) are the coordinates of the reconstructed samples corresponding to the i-th coefficient ci (point symmetry).

### Non-Linear Filtering

When non-linear ALF is enabled, Equation (21) is modified as follows:

$$\overline{R} ( x , y ) = R ( x , y ) + [ {\sum }_{i = 0}^{N - 2} {c}_{i} \times ( {f}_{i}^{+} + {f}_{i}^{-} ) + 64 ] ≫ 7 \qquad ( 23 )$$

$$With : {f}_{i}^{+} = min ( {b}_{i} , max ( - {b}_{i} , R ( x + {x}_{i} , y + {y}_{i} ) - R ( x , y ) ) ) \qquad ( 24 )$$

$${f}_{i}^{-} = min ( {b}_{i} , max ( - {b}_{i} , R ( x - {x}_{i} , y - {y}_{i} ) - R ( x , y ) ) )$$

Where bᵢ is the clipping parameter for the coefficient cᵢ, that is determined by a clipping index dᵢ. The clipping parameter bᵢ is derived as follows:

$${b}_{i} = \{ \begin{matrix}{2}^{BD} & when {d}_{i} = 0 \\ {2}^{BD - 1 - 2 {d}_{1}} & otherwise\end{matrix} \qquad ( 25 )$$

Where BD denotes the sample bit depth, and dᵢ can be 0, 1, 2 or 3.

### Luma Sub-Block Classification

Filter adaptation at sub-block level only applies to Luma. Each 4×4 block is classified based on its directionality and Laplacian activity.

First, the values of sample gradients for horizontal, vertical and two diagonal directions are calculated:

$${H}_{k , l} = \vert 2 R ( k , l ) - R ( k - 1 , l ) - R ( k + 1 , l ) \vert \qquad ( 26 )$$

$${V}_{k , l} = \vert 2 R ( k , l ) - R ( k , l - 1 ) - R ( k , l + 1 ) \vert$$

$$D {0}_{k , l} = \vert 2 R ( k , l ) - R ( k - 1 , l - 1 ) - R ( k + 1 , l + 1 ) \vert$$

$$D {1}_{k , l} = \vert 2 R ( k , l ) - R ( k - 1 , l + 1 ) - R ( k + 1 , l - 1 ) \vert$$

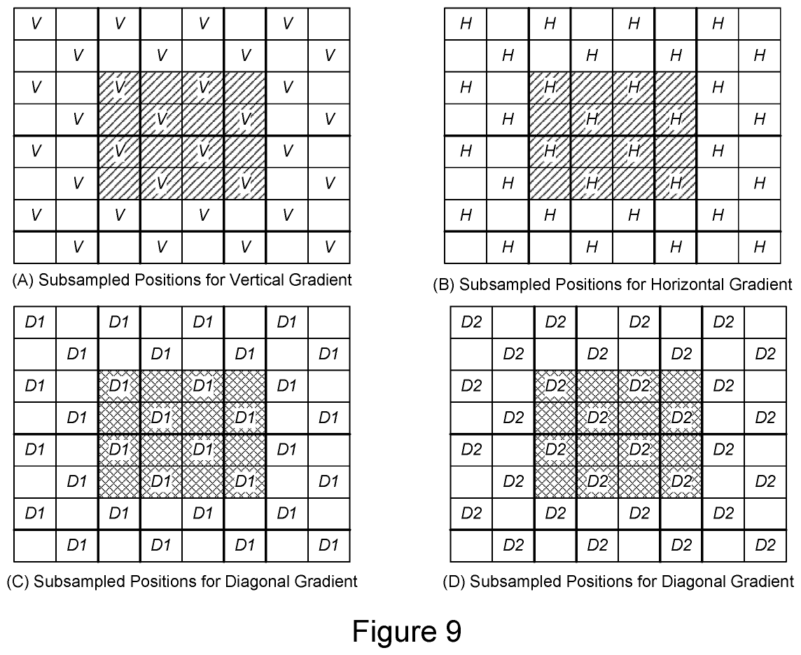

Based on the sample gradients, sub-block horizontal gradient gₕ, vertical gradient gᵥ, and two diagonal gradients g_{d0} and g_{d1}, are calculated as:

$${g}_{h} = {\sum }_{k = i - 2}^{i + 5} {\sum }_{l = j - 2}^{j + 5} {H}_{k , l} \qquad ( 27 )$$

$${g}_{v} = {\sum }_{k = i - 2}^{i + 5} {\sum }_{l = j - 2}^{j + 5} {V}_{k , l}$$

$${g}_{d 0} = {\sum }_{k = i - 2}^{i + 5} {\sum }_{l = j - 2}^{j + 5} D {0}_{k , l}$$

$${g}_{d 1} = {\sum }_{k = i - 2}^{i + 5} {\sum }_{l = j - 2}^{j + 5} D {1}_{k , l}$$

Where indices i and j refer the coordinates of the upper left sample in the 4×4 Luma block. As can be seen from Equations (27), the sum of sample gradients within a 10×10 Luma window that covers the target 4×4 block is used for classifying that block. To reduce the complexity, only gradients of every second sample in the 10×10 window is calculated as illustrated in FIG. 9. The values of other sample gradients are set to 0.

Second, to assign the directionality D, the ratio of the maximum and minimum of the sub-block horizontal and vertical gradients

$${g}_{h , v}^{ma x} = max ( {g}_{h} , {g}_{v} ) , {g}_{h , v}^{m i n} = min ( {g}_{h} , {g}_{v} ) \qquad ( 28 )$$

and the ratio of the maximum and the minimum of two sub-block diagonal gradients

$${g}_{d 0 , d 1}^{ma x} = max ( {g}_{d 0} , {g}_{d 1} ) , {g}_{d 0 , d 1}^{m i n} = min ( {g}_{d 0} , {g}_{d 1} ) \qquad ( 29 )$$

are compared against each other and with a set of thresholds tᵢ and t₂:

### Step 1.

If both

$${g}_{h , v}^{m ax} \leq {t}_{1} \times {g}_{h , v}^{m i n} and {g}_{d 0 , d 1}^{m ax} \leq {t}_{1} \times {g}_{d 0 , d 1}^{min} ,$$

D is set to 0 (block is categorized as “texture”)

### Step 2.

If

$${g}_{h , v}^{ma x} / {g}_{h , v}^{m i n} > {g}_{d 0 , d 1}^{m ax} / {g}_{d 0 , d 1}^{m i n} ,$$

the directionality D is calculated in Step 3; otherwise in Step 4.

### Step 3.

If

$${g}_{h , v}^{m ax} > {t}_{2} \times {g}_{h , v}^{m i n} ,$$

D is set to 2 (block is categorized as “strong horizontal/vertical”); otherwise D is set to 1 (block is categorized as “weak horizontal/vertical”).

### Step 4

If

$${g}_{d 0 , d 1}^{m ax} > {t}_{2} \times {g}_{d 0 , d 1}^{m i n} ,$$

D is set to 4 (block is categorized as “strong diagonal”); otherwise D is set to 3 (block is categorized as “weak diagonal”).

Third, an activity value A is calculated as:

$$A = ( {\sum }_{k = i - 2}^{i + 5} {\sum }_{l = j - 2}^{j + 5} ( {V}_{k , l} + {H}_{k , l} ) ) ≫ ( BD - 2 ) \qquad ( 30 )$$

The activity value A is further mapped to the range of 0 to 4, inclusively, and the quantized value is denoted as Â.

Finally, each 4×4 Luma block is categorized into one of the 25 classes:

$$C = 5 D + \hat{A} \qquad ( 33 )$$

Each class can have its own filter assigned.

Note that no classification method is applied for Chroma.

### Geometric Transformations

Before filtering each 4×4 luma block, a geometric transformation such as rotation or diagonal and vertical flipping is applied to the filter coefficients, depending on the sub-block gradient values as specified in Table 2. The goal is to align the directionally of the different blocks, to reduce the number of ALF classes. Applying the geometric transformation allows a 4×4 block with a horizontal edge and a 4×4 block with a vertical edge to both have the same directionality D.

TABLE 2
Geometric transformation based on sub-block gradient values

| Gradient values | Transformation |
|---|---|
| g_{d1} < g_{d0} and gₕ < gᵥ | No transformation |
| g_{d1} < g_{d0} and gᵥ < gₕ | Diagonal |
| g_{d0} < g_{d1} and gₕ < gᵥ | Vertical flip |
| g_{d0} < g_{d1} and gᵥ < gₕ | Rotation |

### CTB-Level Filter Selection

In addition to the Luma 4×4 block-level classification, ALF presents filter adaptation at the level of Coding Tree Blocks (CTB).

A Luma CTB can use a filter set calculated for the current slice or one of the filter sets calculated for the already coded slices. It can also use one of the 16 offline trained filter sets. Within each Luma CTB, which filter from the chosen filter set should be applied to each 4×4 block, is determined by the class C calculated in Equation (31) for this block.

Chroma uses only CTB-level filter adaptation. Up to 8 filters can be used for Chroma components in a slice. Each CTB select one these filters.

### ALF Syntax in WC

Filter coefficients and clipping indices are carried in ALF Adaptation Parameter Sets (APS). An ALF APS can include up to 8 Chroma filers and one Luma filter set with up to 25 filters. An index i_{c} is also included for each of the 25 Luma classes. Classes having the same index i_{c} share the same filter. By merging different classes, the number of bits required to represent the filter coefficients is reduced. The absolute value of a filter coefficient is represented using a 0^{th} order Exp-Golomb code followed by a sign bit for non-zero coefficients. When clipping is enabled, a clipping index is also signaled for each filter coefficient using a two-bit fixed length code.

Filter control syntax elements include two types of information. First, ALF On/Off flags are signaled at sequence, picture, slice and CTB levels. Chroma ALF can be enabled at picture and slice level only if Luma ALF is enabled at the corresponding level. Second, filter usage information is signaled at picture, slice and CTB level, if ALF is enables at that level. Referenced ALF APS IDs are coded at a slice level or at picture level if all the slices within the picture use the same APSs. Luma component can reference up to seven ALF APSs and Chroma components can reference one ALF APS. For a Luma CTB, an index is signaled indicating which ALF APS or offline trained Luma filter set is used. For a Chroma CTB, the index indicates which filter in the referenced APS is used.

### At Encoder Side

The encoder calculates values of ALF syntax (see previous subsection) by minimizing a rate-distortion cost, which is a weighted sum of the distortion, measured as the square error between the original samples and the sample after applying the ALF filter, and the number of bits required to transmit ALF syntax elements.

Filter coefficients are calculated by solving Wiener-Hopf equations. The statistics required to calculate filter coefficients and estimate distortion are collected for all possible combinations of clipping indices. The statistics are collected separately for each CTB, and in case of Luma component, for each class of each CTB.

### Luma Component

For each picture, a new filter set for Luma component based on this picture's statistics, denoted as F_{Y,D}, is obtained as follows:
1) The encoder derives the filter set F_{Y,D} by merging statistics of the CTBs for which ALF is enabled. At first iteration, it is assumed that ALF is enabled for all CTBs.
2) Whether to apply ALF filter is determined for each CTB based on the rate-distortion cost calculated using the derives filters and the statistics of the CTB.

In VTM-9.0, steps 1) and 2) are repeated four times.

### Optimizing a Luma Filter Set

When designing a Luma filter set in Step 1), the encoder first calculates a filter for each of the 25 Luma classes. Then a merging algorithm is applied to these 25 filters. At each iteration, by merging two filters, the algorithm reduces the number of filters by one. To determine with two filters should be merged, for every pair of remaining filters, the encoder redesigns a filter by merging two filters and the corresponding statistics. Using the redesigned filter, the distortion is then estimated. The encoder merges the pair with the smallest distortion. Twenty-five (25) filter sets are obtained, the first set having 25 filters, the second one 24 filters, and so on until the 25^{th} one contains a single filter. Eventually, the set which minimizes a rate-distortion cost, including bits required to code the filter coefficients, is selected.

### Luma Filter Optimization

When designing a filter, the clipping indices and the (N-1) filter coefficients are calculated iteratively until there is no decrease of the square error. In each iteration, the values of the clipping indices are updated one by one, starting with d₀ and continuing till index d_{N-2} is reached. When updating the index, up to three options are tested: keeping its value unchanged, incrementing by one or decrementing by one. The filter coefficients and the approximate distortion are calculated for these 3 values and the value which minimizes square error is selected. At first iteration, the values of clipping indices are initialized to 2. When merging two filters, the value of dᵢ is set to the average of the corresponding clipping indices for these filters.

Luma component can also use the offline trained filter sets and the Luma filter sets carried in available ALF APSs. By accessing APSs, from the most recently signaled to the last one, the encoder obtains up to 7 Luma filter sets, which are denoted as

$${F}_{Y , APS}^{i} ,$$

where i∈ [symbol] 0; (N_{APS}−1) [symbol] . The final values of the Luma ALF syntax element are obtained by selecting the combination of filter sets F_{i,j}, where i∈{0; 1} and j∈ [symbol] 0;N_{APS} [symbol] among:
a. 16 offline trained filter sets;
b. F_{Y,D}, if i=1;
c. And

$$\{ {F}_{Y , APS}^{0} , … , {F}_{Y , APS}^{j - 1} \} ,$$

if j>0.

### Chroma Components

Based on the current picture statistics, a Chroma filter set F_{C,D} is calculated. Eight (8) Chroma filter sets are derived, denoted as

$${F}_{C , D}^{i}$$

where i∈ [symbol] 1; 8 [symbol] . Filter set

$${F}_{C , D}^{i}$$

contains i filters. The filter set

$${F}_{C , D}^{i}$$

is obtained as follows:
1) The current picture is uniformly partitioned into i regions. For each region, a Chroma filter is calculated by merging the statistics of all CTBs in this region.
2) For each Chroma CTB in the picture, ALF On/Off flag and the filter index from set F_{C,D} ⁱ is determined as to minimize the estimated rate-distortion cost.
3) Each filter in F_{C,D} ⁱ is re-designed, by merging statistics of Chroma CTBs for which the current to-be-redesigned filter was selected in Step 2).
4) Steps 2) and 3) are repeated (i+1) times.

The filter

$${F}_{C , D}^{i}$$

that minimizes rate-distortion cost is selected as Chroma filter set F_{C,D}. Finally, the encoder selects F_{C,D} or one of the Chroma filter sets from the available APSs to be used for the Chroma components.

### Further ALF Developments in ECM (Unstandardized Yet)

### New Classifier and Fixed Filtering for Luma

Since ECM-3.0, a new classifier has been introduced which is based on Luminance bands. Let C0 denote the legacy Laplacian-based classifier (see Luma sub-block classification) and let C1 denote the new band classifier.

To filter a Luma sample, three different sets of filters (F0, F1 and F2) are used. Sets F0 and F1 contain “fixed” filters, with coefficients trained for classifiers C0 and C1. Coefficients of filters in F2 are signaled. Let R₀(x,y) and R₁(x,y) denote the intermediate sample values filtered by F0 and F1, respectively. The filter F2 is applied to R₀(x,y), R₁(x,y), and the neighboring samples in order to derive a final filtered sample as:

$$\overline{R} ( x , y ) = R ( x , y ) + [ {\sum }_{i = 0}^{19} {c}_{i} \times ( {f}_{i}^{+} + {f}_{i}^{-} ) ] + [ {\sum }_{i = 20}^{21} {c}_{i} \times {g}_{i} ] \qquad ( 32 )$$

Where

$${f}_{i}^{+ / -}$$

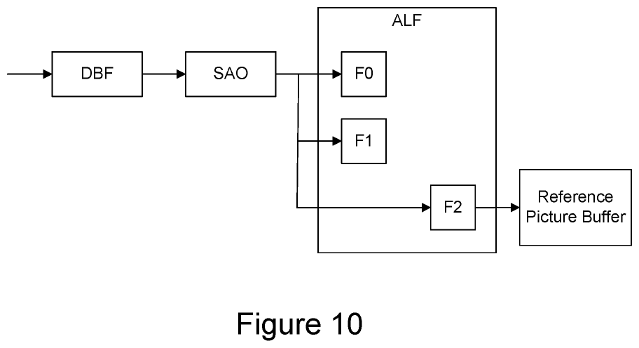

denotes the clipped difference between a neighboring sample and R(x,y), and gᵢ denotes the clipped difference between R₂₀₋ᵢ(x,y) and current sample value. The FIG. 10 recaps the new process.

The filter coefficients (cᵢ)_{0≤i≤21} are signaled.

### Latest Developments

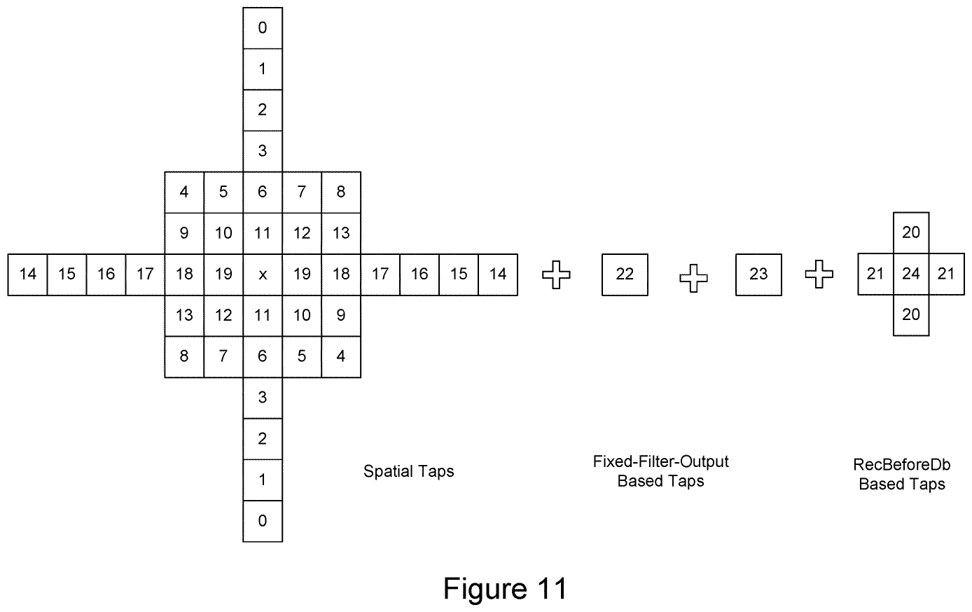

Latest adoptions in ECM include changes in filter shapes and sizes, and taking into account samples before deblocking in the signaled filter, as depicted in FIG. 11.

Regarding contributions, most involve further diversification of signaled filter input, with for instance collocated samples in reference pictures, pre-DBF samples once filtered by a fixed filter, or residual samples. Last, a further classifier based on residue L1 has been proposed.

### Adaptive Wiener Deblocking Filters

The described embodiments comprise using deblocking filters that depend on a novel local classification, where the deblocking filters may be adaptively selected and signaled in the bitstream for the different classes. The corresponding plurality of deblocking filters, which is referred to as a deblocking filter set, is either signaled in the bitstream, or pre-learned and known both at encoder and decoder sides. Another aspect of the embodiments is that the DBF activation and filters usage can be controlled at a lower level than the slice level, for instance at CTU level.

Deblocking is performed along borders of Coding Units (CUs), Prediction Units (PUs) and Transform Units (TUs).

In an embodiment, the deblocking classification is sample-wise, and takes into account both the distance from the block boundaries and specific features of those boundaries.

### Embodiment on Signaling of the Deblocking Filters

In the embodiment where the deblocking filters used are not pre-learned, the corresponding deblocking filter sets are signaled in the bitstream, e.g., at tile, slice or picture level.

In an embodiment, signaled deblocking filter sets are determined at encoder side by minimizing a distortion error (for instance, the squared error, or the sum of absolute difference) between reconstructed samples and original values across block boundaries.

One main difference with respect to prior DBF solutions is that deblocking filters are signaled in the bitstream and that they are derived from the pictures content. One main difference with respect to ALF lies in the classification used.

One benefit from the embodiments is that, compared to the current DBF, the proposed solution may improve the signal fidelity of the filtered signal by integrating in the derivation of the
deblocking filters constraints to remain close to the original signal, while current DBF only mostly targets visual reduction of blocking artefacts.

### Embodiment on Combining ALF and DBF Steps into One Step

In an embodiment, the DBF process is removed, and the ALF process is enhanced by new classes and related filters specialized for reducing blocking artefacts. This advantageously simplifies the process design and may reduce the overall number of processing steps (the samples previously processed by DBF then ALF will now be only processed once by ALF).

The following sections provide more details on the described aspects and on its embodiments.

### Block Boundaries

Deblocking is performed across block boundaries on borders of Coding Units, Prediction Units (or Prediction Blocks), and Transform Units (or Transform Blocks)

In an embodiment, that corresponds to the way VVC DBF is implemented in the Reference Software, the determination of block boundaries is made through scanning all CUs per CTU, for all CTUs.

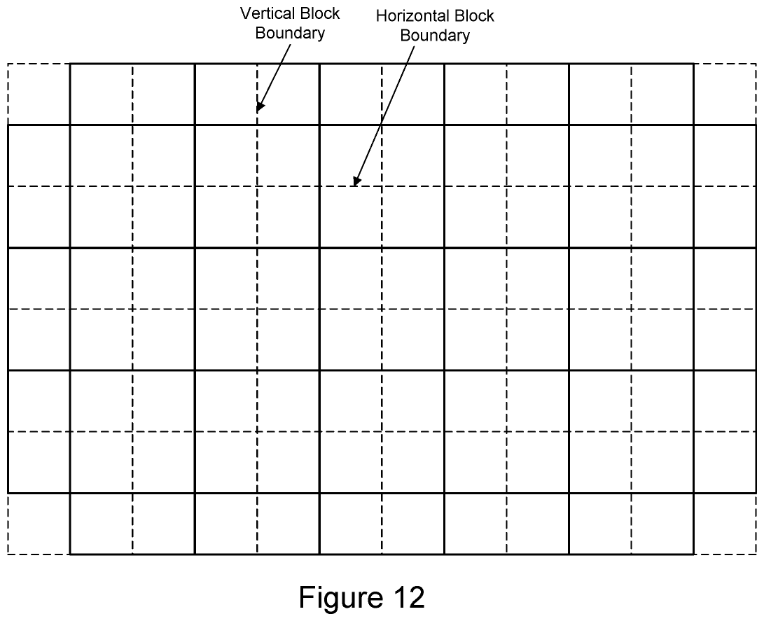

In another embodiment, the current slice/picture is first partitioned into a regular block grid for convenience, then block boundaries of that first grid are parsed, looking for CU, PU and TU borders. The resulting deblocking grid is shifted from the first grid with vertical and horizontal block boundaries lying in the middle of each shifted block (see FIG. 12). Consequently, some shifted blocks located on slice/pictures borders present a rectangular shape M×2M or 2M×M.

The described aspects are not limited on a specific grid size, such as 8×8, 4×4 or 2×2.

### Spatial Range

In an embodiment of the present aspects, every sample can be deblocked.

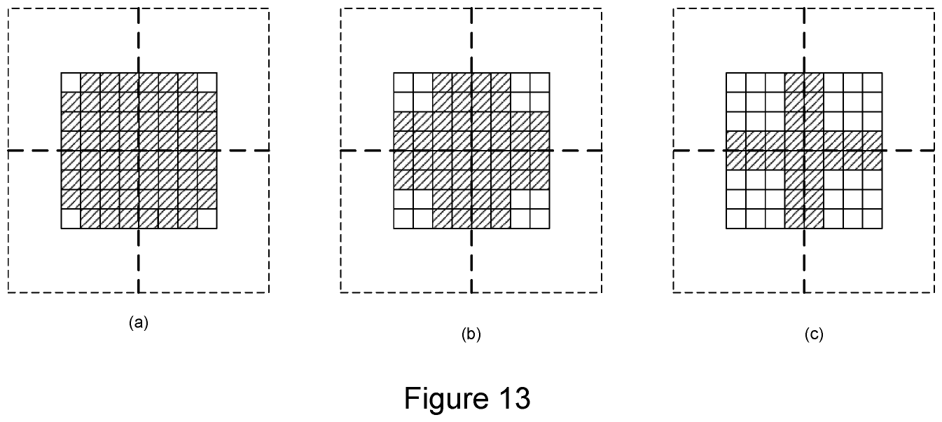

In another embodiment, some samples are a priori excluded from the deblocking process depending on their position on the deblocking grid (see FIG. 13).

### Classification

The deblocking process derives from a local classification. In one variant, that classification is sample-wise. In another variant, the classification is block-based. In this variant, the classification may be achieved using the same block-size as used by ALF.

Deblocking filter sets consist in a plurality of deblocking filters, and samples are processed with a specific filter depending on their class, similarly to ALF.

In an embodiment, class/filter merging is considered during deblocking filter optimization at encoder side. Class merging implies that the corresponding filters present the exact same shape and coefficients location (more details in next section).

The described aspects are not limited on the classification used. For instance, it can rely on local signal features such as gradients, Laplacian activity, and/or Luma/Chroma bands.

### Spatiality

In an embodiment, the deblocking classification depends at least partially on the distance from the sample to the closest horizontal and vertical block boundaries.

Let d_{H} and d_{V} denote the distances to the closest horizontal and vertical block boundaries, respectively.

The spatiality index S is defined as:

$$S = [ {\sum }_{i = 0}^{m i n ( {d}_{H} , {d}_{V} )} ( \frac{N}{2} - i ) ] + max ( {d}_{H} , {d}_{V} ) - min ( {d}_{H} , {d}_{V} )$$

where N denotes the size of the deblocking grid size.

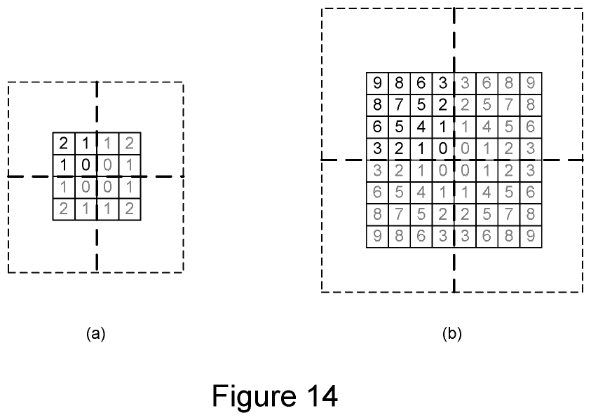

FIG. 14 depicts examples of such spatial classification for 4×4 and 8×8 grid sizes. Spatial classification exhibits horizontal, vertical, and diagonal symmetries.

In the embodiment related to spatial range, where some specific spatial locations are excluded from the deblocking process), some of the higher spatiality indices are discarded, and the resulting number of spatial classes is reduced.

### Boundaries Features

In another embodiment, the deblocking classification depends locally on the characteristics of closest horizontal and vertical boundaries.

### Definition

That dependency involves especially the knowledge of the tile/slice/picture partitioning and coding, e.g.:
a. Is that block boundary located on a CU/PU/TU border?
b. Is at least one of the blocks intra coded?
c. Does at least one of the blocks have non-zero coded residual?
d. Is the absolute difference between corresponding spatial motion vectors above a given threshold?
e. Do motion compensation predictions for the two blocks refer to different reference pictures?
f. Is the number of motion vectors used for motion compensation the same for the two blocks?

In an embodiment, the deblocking classification also involves criteria that characterize signal variations across block boundaries. Such criteria measure the signal activity, based for instance on gradients or Laplacian operators.

### Boundary Features Index

In an embodiment, a horizontal boundary features index bF_{H} and a vertical boundary features index bF_{V} are defined, and a boundary features index bF depends on both:

$$b F = f ( b {F}_{H} , {bF}_{V} )$$

Horizontal and vertical boundary features indices bF_{H} and bF_{V} can take values in the integer range [symbol] 0; (n-1) [symbol] , where n is a natural number greater than 1.

The boundary features index bF is defined as follows:

$$bF = b {F}_{H} + n \times b {F}_{V}$$

$$Or alternatively : bF = b {F}_{H} \times n + b {F}_{V}$$

In an embodiment, boundary features rely on the boundary strength criterion Bs defined in HEVC and VVC DBF [Norkin2012, Karczewicz2021, JVET-T2002](see Table 1), which values are 0, 1 or 2 (that is, n=3). In that case:

$$bF = B {s}_{H} + 3 \times B {s}_{V}$$

$$Or alternatively : bF = B {s}_{H} \times 3 + B {s}_{V}$$

No-Deblocking Boundary Features Class Vs. Local Flag Signaling

In a preferred embodiment, a predetermined value of bF_{H} and bF_{V} (e.g., zero) turns off deblocking in that direction. That reserved value impacts filters' shapes, as described in Table 3.

TABLE 3
Effects of reserved boundary features index values.

| | bF_{H} = 0 | bF_{H} > 0 |
|---|---|---|
| bF_{V} = 0 | No Deblocking | 1D horizontal |
| | | deblocking filter |
| bF_{V} > 0 | 1D vertical deblocking | 2D deblocking filter |
| | filter | |

In that embodiment, deblocking is turned off depending on local classification, without requesting any syntax. This comes down to the way DBF is implemented in HEVC and VVC.

In another embodiment, deblocking control relies on the signaling of a local flag. That embodiment is similar to what happens in ALF.

### Deblocking Class Index and Filter Transposition

A deblocking class index C_{D} is defined, that depends on both spatiality and boundaries features.

In an embodiment, the deblocking class index C_{D} derives from spatiality index S and boundary features index bF.

Let n denote the range of unidirectional boundary features indices. The deblocking class index is computed as:

$${C}_{D} = b F + S \times {n}^{2}$$

Or alternatively, if N denotes the deblocking grid size:

$${C}_{D} = bF \times [ \frac{N}{2} + \frac{N / 2 \cdot ( N / 2 - 1 )}{2} ] + S$$

Table 4 provides specific examples of deblocking class indexing in function of the decoding grid size and of the range of boundary features indices.

TABLE 4
Deblocking class index in function of grid size
and unidirectional boundary features range.

| | 4 × 4 grid | 8 × 8 grid |
|---|---|---|
| bF_{H, V} ∈ [[0; 1]] | C_{D} = bF + S × 4 | C_{D} = bF + S × 4 |
| | or C_{D} = bF × 3 + S | or C_{D} = bF × 10 + S |
| bF_{H, V} ∈ [[0; 2]] | C_{D} = bF + S × 9 | C_{D} = bF + S × 9 |
| | or C_{D} = bF × 3 + S | or C_{D} = bF × 10 +S |
| bF_{H, V} ∈ [[0; 3]] | C_{D} = bF + S × 16 | C_{D} = bF + S × 16 |
| | or C_{D} = bF × 3 + S | or C_{D} = bF × 10 + S |

### Filter Transposition and Class Clustering

Transposition is introduced to reduce the total number of classes, as presented for spatiality above.

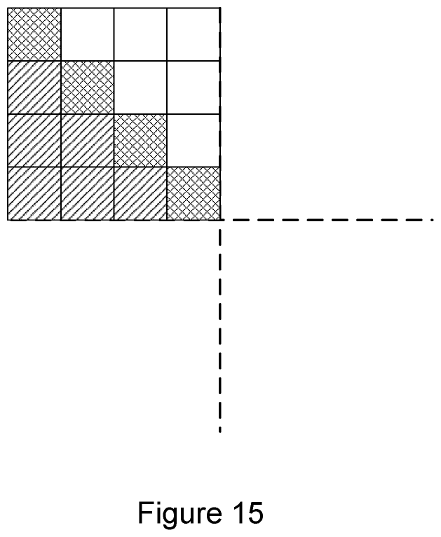

In a preferred embodiment, deblocking filter transposition is also used for samples lying on the bisector of the deblocking grid (dark-gray samples in FIG. 15), to further benefit from the symmetry between horizontal and vertical boundary features indices.

The resulting class clustering policy is described in Table 5.

TABLE 5
Filter transposition for class clustering

| | d_{H} < d_{V} | d_{H} = d_{V} | d_{H} > d_{V} |
|---|---|---|---|
| bF_{V} < bF_{H} | No | No | Filter |
| | transform | transform | transposition |
| | | | (switch bF_{V}, bF_{H}) |
| bF_{V} = bF_{H} | No | No | Filter |
| | transform | transform | transposition |
| bF_{V} > bF_{H} | No | Filter | Filter |
| | transform | transposition | transposition |
| | | (switch bF_{V}, bF_{H}) | (switch bF_{V}, bF_{H}) |

The following tables provide practical examples in the specific cases where n=2 and n=3 for a 4×4 grid, in the preferred embodiment where bF_{Hv}=0 turns off the deblocking.

TABLE 6
Deblocking class indexing for n = 2 in 4 × 4 grid (7 classes)

| | | | | | | Filter |
|---|---|---|---|---|---|---|
| C_{D} | d_{V} | d_{H} | S | bF_{V} | bF_{H} | transposition |
| 0 | 0 | 0 | 0 | 0 | 1 | No |
| 0 | 0 | 0 | 0 | 1 | 0 | Yes |
| 1 | 0 | 0 | 0 | 1 | 1 | No |
| 2 | 0 | 1 | 1 | 0 | 1 | No |
| 2 | 1 | 0 | 1 | 1 | 0 | Yes |
| 3 | 0 | 1 | 1 | 1 | 0 | No |
| 3 | 1 | 0 | 1 | 0 | 1 | Yes |
| 4 | 0 | 1 | 1 | 1 | 1 | No |
| 4 | 1 | 0 | 1 | 1 | 1 | Yes |
| 5 | 1 | 1 | 2 | 0 | 1 | No |
| 5 | 1 | 1 | 2 | 1 | 0 | Yes |
| 6 | 1 | 1 | 2 | 1 | 1 | No |

TABLE 7
Deblocking class indexing for n = 3 in 4 × 4 grid (18 classes)

| | | | | | | Filter |
|---|---|---|---|---|---|---|
| C_{D} | d_{V} | d_{H} | S | bF_{V} | bF_{H} | transposition |
| 0 | 0 | 0 | 0 | 1 | 0 | Yes |
| 0 | 0 | 0 | 0 | 0 | 1 | No |
| 1 | 0 | 0 | 0 | 0 | 2 | No |
| 1 | 0 | 0 | 0 | 2 | 0 | Yes |
| 2 | 0 | 0 | 0 | 1 | 1 | No |
| 3 | 0 | 0 | 0 | 1 | 2 | No |
| 3 | 0 | 0 | 0 | 2 | 1 | Yes |
| 4 | 0 | 0 | 0 | 2 | 2 | No |
| 5 | 0 | 1 | 1 | 0 | 1 | No |
| 5 | 1 | 0 | 1 | 1 | 0 | Yes |
| 6 | 0 | 1 | 1 | 0 | 2 | No |
| 6 | 1 | 0 | 1 | 2 | 0 | Yes |
| 7 | 0 | 1 | 1 | 1 | 0 | No |
| 7 | 1 | 0 | 1 | 0 | 1 | Yes |
| 8 | 0 | 1 | 1 | 1 | 1 | No |
| 8 | 1 | 0 | 1 | 1 | 1 | Yes |
| 9 | 0 | 1 | 1 | 1 | 2 | No |
| 9 | 1 | 0 | 1 | 2 | 1 | Yes |
| 10 | 0 | 1 | 1 | 2 | 0 | No |
| 10 | 1 | 0 | 1 | 0 | 2 | Yes |
| 11 | 0 | 1 | 1 | 2 | 1 | No |
| 11 | 1 | 0 | 1 | 1 | 2 | Yes |
| 12 | 0 | 1 | 1 | 2 | 2 | No |
| 12 | 1 | 0 | 1 | 2 | 2 | Yes |
| 13 | 1 | 1 | 2 | 0 | 1 | No |
| 13 | 1 | 1 | 2 | 1 | 0 | Yes |
| 14 | 1 | 1 | 2 | 0 | 2 | No |
| 14 | 1 | 1 | 2 | 2 | 0 | Yes |
| 15 | 1 | 1 | 2 | 1 | 1 | No |
| 16 | 1 | 1 | 2 | 1 | 2 | No |
| 16 | 1 | 1 | 2 | 2 | 1 | Yes |
| 17 | 1 | 1 | 2 | 2 | 2 | No |

### Deblocking Filters.

### Filter Coefficients

Regardless of its shape and size, a deblocking filter is determined by its coefficients. Let K denote their number.

Filters coefficients are signaled as signed integers coded on nb_{bits} its bits, similarly to ALF implementations in WC and ECM.

### Straightforward Deblocking Implementation

A reconstructed sample t[r] is filtered into its deblocked version f[r] as follows:

$$f [ r ] = [ ( {\sum }_{k = 0}^{K - 1} {c}_{k} \cdot t [ r + {p}_{k} ] ) + {2}^{{nb}_{bits} - 2} ] \times \frac{1}{{2}^{n {b}_{b i t s} - 1}}$$

where the above operations consist in integer arithmetic, and where in particular multiplication and divisions involving powers of two can be implemented by bitwise left and right shifts;
and where r denotes the current position of to-be-deblocked sample, and (pₖ)_{k<K} denote the sample position offsets corresponding to deblocking filter coefficients (Cₖ)_{k<K}.
   Deblocking with DC-Neutral Filters

In a preferred embodiment, DC-neutrality of deblocking filters is enforced, that is,

$${\sum }_{k = 0}^{K - 1} {c}_{k} = 1 ,$$

and a reconstructed sample t[r] is filtered into its deblocked version f[r] as follows:

$$f [ r ] = [ ( t [ r ] + {\sum }_{k = 0}^{K - 2} {c}_{k} \cdot ( t [ r + {p}_{k} ] - t [ r ] ) ) + {2}^{{nb}_{bits} - 2} ] \times \frac{1}{{2}^{n {b}_{b i t s} - 1}}$$

where the above operations consist in integer arithmetic, and where in particular multiplication and divisions involving powers of two can be implemented by bitwise left and right shifts,
and where r denotes the current position of to-be-deblocked sample, and (pₖ)_{k<K-1} denote the sample position offsets corresponding to deblocking filter coefficients (cₖ)_{k<K-1}, assuming that the null offset is assigned to coefficient C_{K-1}.

### Deblocking Filter Shapes

In the described embodiments, at least some deblocking filters present 2D shapes, unlike existing DBF solutions.

The described aspects are not limited to a specific configurations of filter shapes or sizes.

### Shared Filter Shape

In an embodiment, every sample is filtered with the same filter shape, of same size, with the same coefficient layout. This favors filter merging during optimization at encoder side. That shape can be a square, a cross, a diamond, or any combination of square, rectangle, cross and diamond.

### Centered Filter Shape

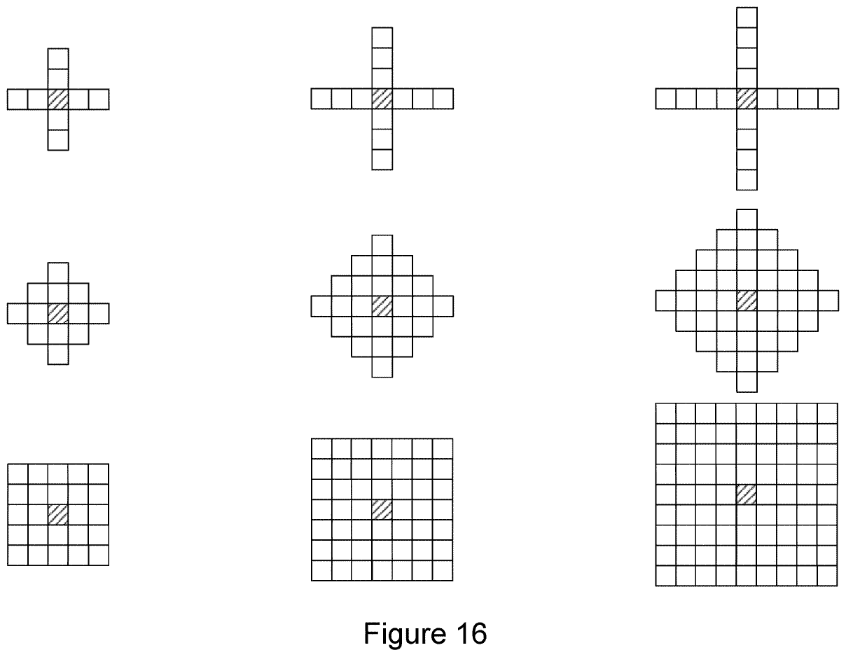

In an embodiment, the common filter shape is odd-size and centered: the current to-be-filtered sample is located at the center of the filter shape (see FIG. 16 for basic shapes).

### Off-Centered Filter Shapes

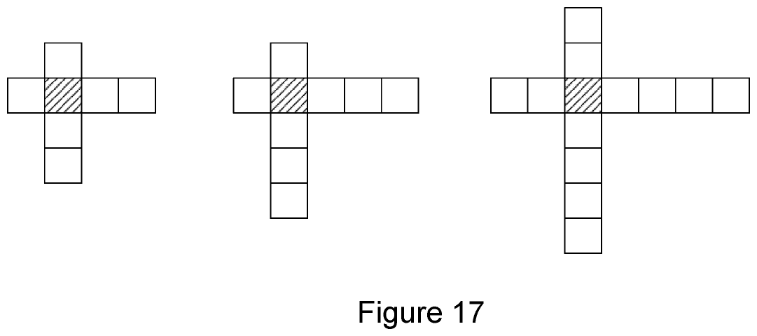

In another embodiment, the common filter shape is off-centered, that is: the filter shape covers more samples towards horizontal and vertical block boundaries than on the other side (see FIG. 17).

In that embodiment, filter shapes can be even- or odd-sized.

### Spatially Dependent Filter Shapes

In an embodiment different from in shared filter shape, filter shapes depend on the location of the current sample to be filtered. This prevents filter merging between spatial classes that are not transposed from each other.

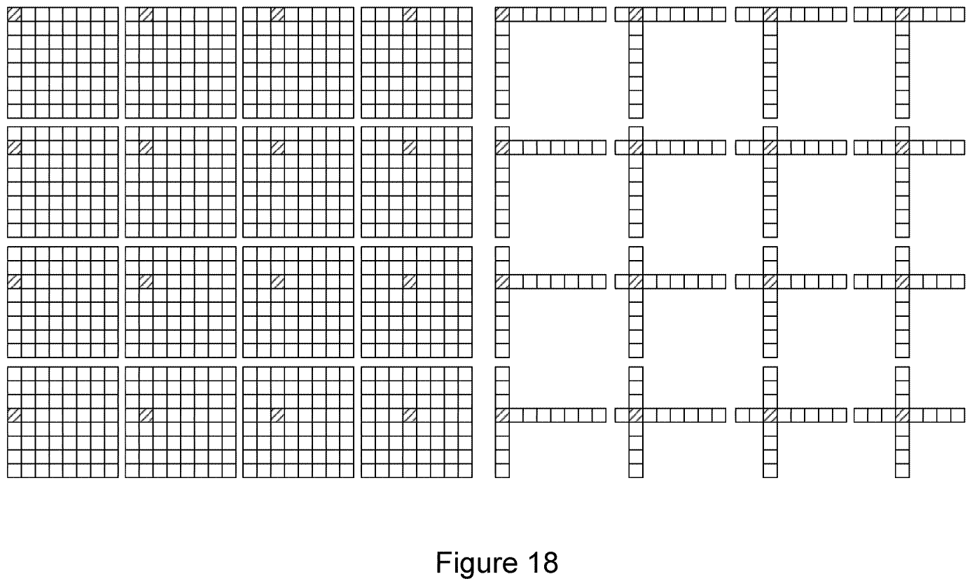

FIG. 18 depicts two examples of spatially dependent filter sets for top-left quadrant.

### Boundary Features Dependent Filter Shapes

In an embodiment, the dimensionality of the filter shape depends on boundary features (see section on no-deblocking boundary features class vs. local flag signaling).

In that embodiment, a predetermined value of bF_{H} and bF_{V} (e.g., zero) turns off deblocking in that direction, that is, the filter shape is 1 D, as described in Table 3.

That embodiment can be combined with spatially dependent filter shapes (3.4.2.2), in which case deblocking filter shapes depend on both spatiality and boundaries features.

Use of Pre-Defined Filters with Signaling of Corrective Coefficients

In one embodiment, default deblocking filters are defined (for instance, those already defined in VVC for DBF), and corrective coefficients, with limited amplitude, are signaled. Hence, the visual benefits from existing DBF filters is maintained, and corrective coefficients may slightly adjust these filters to better improve the signal fidelity.

The signaling of DBF corrective coefficients can be done in HLS, for instance in picture header, in slice header, in APS. It can also be made more local, for instance at tile, sub-picture, CTU levels. This gives more flexibility to adapt the filters locally to the spatial content changes.

The corrective coefficients may be learned at encoder side to minimize the MSE between the filtered samples and the original samples, while keeping a constraint that they have to remain in a limited amplitude range (e.g., from −2 to +2 per coefficient).

### Deblocking Syntax Elements

### Deblocking Filter Set

Deblocking filter sets are signaled for instance at picture, slice or tile level, for instance in a dedicated Adaptation Parameter Set (APS), similarly to ALF implementations in VVC and ECM.

### Deblocking Filter Coefficients

Deblocking filter coefficients are signaled as signed integers, for instance with their absolute value Exp-Golomb-coded with order k equal to 0 followed by a sign-bit for non-zero coefficients.

Filters with Various Numbers of Coefficients

In the embodiment where signaled deblocking filters can have different numbers of coefficients, depending on their associated classes, syntax include additional information, such as binary flags or indices that specify the length of the deblocking filters.

### Local Deblocking Control

In another embodiment, a binary flag is signaled locally, e.g., for each shifted block, to turn off/on the deblocking.

Embodiment where several deblocking filter sets are referenced.

In an embodiment, several deblocking filter sets are referenced at slice or picture level, and an index is signaled locally, e.g., for each shifted block, to specify which deblocking filter set is used among the referenced deblocking filter sets.

### Substitution to Legacy DBF

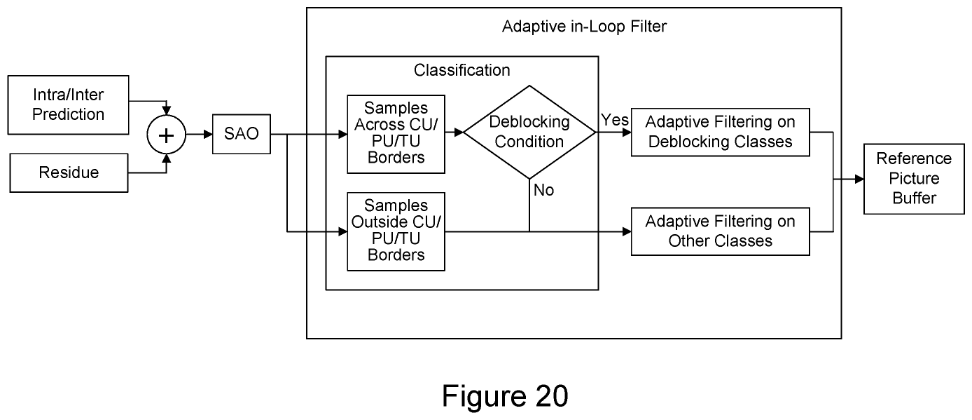

In an embodiment, legacy DBF is not applied after picture reconstruction, and ALF is augmented with the deblocking classes described in the classification section. That is: samples lying across CU/PU/TUs borders that trigger deblocking conditions are filtered with adaptive Wiener deblocking filters, while the remaining samples are filtered with legacy ALF filters using legacy ALF classifiers (Laplacian-based or band-based). The FIG. 20 depicts the corresponding workflow.

This advantageously simplifies the process design and may reduce the overall number of processing steps (the samples previously processed by DBF then ALF will now be only processed once by ALF).

### Filters Optimization at Encoder Side

At encoder side, deblocking filter sets are optimized for a whole slice level or a whole picture.

The method, whatever the embodiment, is quite similar to the optimization of ALF filters in VVC and ECM.

### Filter Coefficient Computation

Filter coefficients are calculated by solving Wiener-Hopf equations, that is:

$$T \cdot c = v$$

$$[ \begin{matrix}\sum t [ r + {p}_{0} ] \cdot t [ r + {p}_{0} ] & \sum t [ r + {p}_{1} ] \cdot t [ r + {p}_{0} ] & … & \sum t [ r + {p}_{K - 1} ] \cdot t [ r + {p}_{0} ] \\ \sum t [ r + {p}_{0} ] \cdot t [ r + {p}_{1} ] & \sum t [ r + {p}_{1} ] \cdot t [ r + {p}_{1} ] & … & \sum t [ r + {p}_{K - 1} ] \cdot t [ r + {p}_{1} ] \\ ⋮ & ⋮ & ⋱ & ⋮ \\ \sum t [ r + {p}_{0} ] \cdot t [ r + {p}_{K - 1} ] & \sum t [ r + {p}_{1} ] \cdot t [ r + {p}_{K - 1} ] & … & \sum t [ r + {p}_{K - 1} ] \cdot t [ r + {p}_{K - 1} ]\end{matrix} ] \cdot [ \begin{matrix}{c}_{0} \\ {c}_{1} \\ ⋮ \\ {c}_{K - 1}\end{matrix} ] = [ \begin{matrix}\sum s [ r ] \cdot t [ r + {p}_{0} ] \\ \sum s [ r ] \cdot t [ r + {p}_{1} ] \\ ⋮ \\ \sum s [ r ] \cdot t [ r + {p}_{K - 1} ]\end{matrix} ]$$

Where T, c and v denote the auto-correlation matrix of the to-be-deblocked samples, the filter coefficients, and the cross-correlation vector of the to-be-deblocked samples t and the source samples s, respectively. Here r denotes the location of the to-be-blocked sample and (pₖ)_{k<K} denote the offset positions corresponding to the deblocking filter (Cₖ)_{k<K}.

### Deblocking Filter Set Computation

The deblocking filter set for the current slice/picture is determined as follows.

First the slice/picture is split into shifted blocks (see FIG. 12), that is, non-overlapping deblocking areas that contain each a vertical block boundary, a horizontal block boundary, or both.

Then the statistics are collected separately for each deblocking class on the whole slice or picture.

Wiener-Hopf equations (see section on substitution to legacy DBF) are solved for each class.

The solutions yield the optimized filter set for the current slice/picture, with an optimal filter per deblocking class.

### Global Deblocking Control at Slice/Picture Level

In the embodiment where no class merging is performed, the decision whether to signal the deblocking filter set at picture/slice level or not is taken by the encoder, based on a rate-distortion criterion.

### Local Deblocking Control

In the embodiment where local control is enabled by flag signaling, the optimization at encoder side is an iterative two-step process.

At initialization, deblocking is enabled in every shifted block.

In a first step, an optimal deblocking filter set is determined based on the statistics of every shifted block where deblocking is enabled. Then in a second step, whether to apply deblocking or not is determined for each shifted block based on a rate-distortion optimization (RDO) condition.

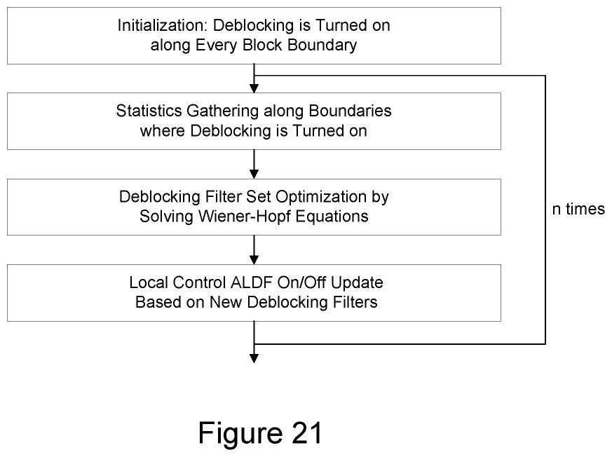

Those two steps are repeated a given number of times, as illustrated in FIG. 21.

### Referencing Several Deblocking Filter Sets

In the embodiment where several deblocking filter sets are references at picture/slice level, the encoder selects locally, e.g., for each shifted block, the best deblocking filter set in regards with a rate-distortion criterion.

### Filter and Class Merging

In the embodiment where deblocking optimization includes filter/class merging, a plurality of deblocking filter sets with different number of classes are tested.

### Iterative Merging Algorithm

First, an optimal deblocking filter set is computed, like in the main embodiment, with an optimal deblocking filter per deblocking class. Then a merging algorithm is applied iteratively.

Filter merging can only be applied on classes that present the same filter shape, size, and layout (same position offsets corresponding to the same filter coefficients), so that their corresponding Wiener-Hopf matrices have the same rank and can be merged into a single one. Let a ‘potential merge pair’ denote a pair of deblocking classes that meets this condition: same filter shape, size and layout.

At each iteration of the merging algorithm, every potential merge pair is considered successively, by merging their corresponding statistics. The pair that exhibits the lowest loss in terms of squared error is kept. The merging algorithm keeps running, as long as a potential pair remains. At each iteration, by merging two filters, the number of classes is decremented by one.

The number of iterations depends on the deblocking filter topology defined at encoder and decoder sides. In the embodiment where every class has the same filter shape, size and layout (see Shared filter shape section), the merging algorithm yields as many deblocking filter sets as initial classes. The initial deblocking filter set contains as many filters as classes, then the next one has one less filter, then the next one another one less, and so on, until the last filter set that contains only one filter, shared by every class.

### Optimal Deblocking Filter Set

Eventually, the encoder selects the deblocking filter set that presents the best RDO performances, considering the error and the signaling cost.

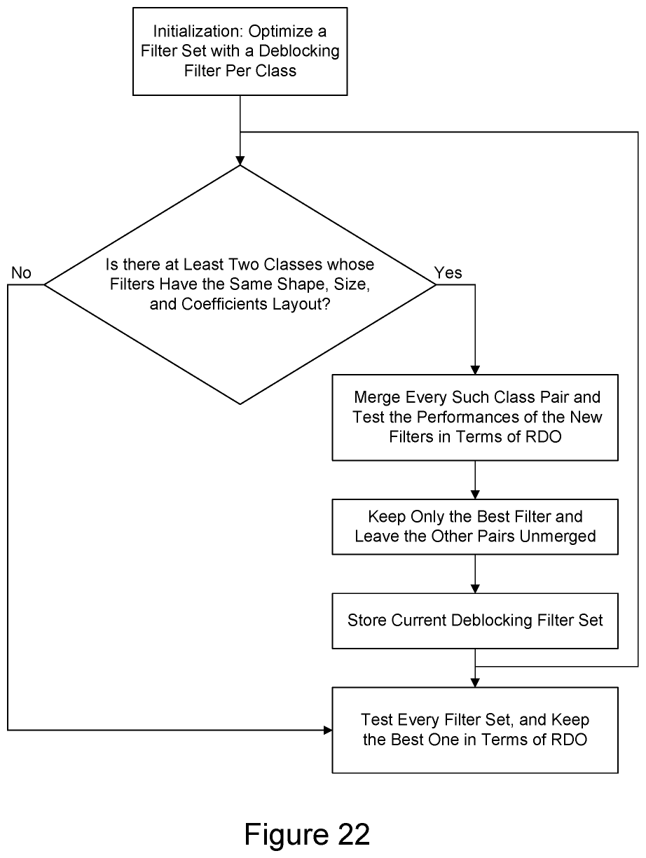

The overall class merging algorithm is illustrated in FIG. 22.

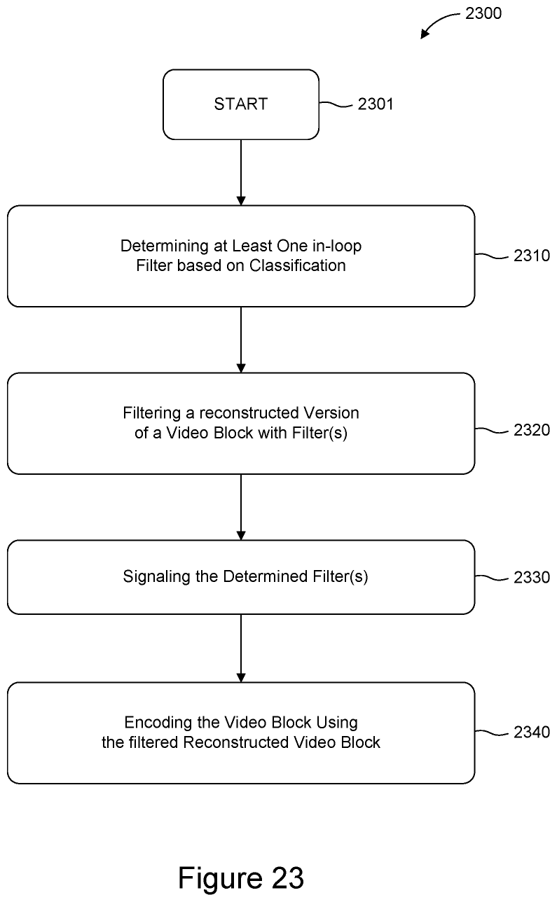

One embodiment of a method 2300 under the general aspects described here is shown in FIG. 23. The method commences at start block 2301 and control proceeds to block 2310 for determining at least one in-loop filter for a video block based on a classification. Control proceeds from block 2310 to block 2320 for filtering a reconstructed version of said video block with said determined at least one in-loop filter. Control proceeds from block 2320 to block 2330 for signaling said determined at least one in-loop filter. Control proceeds from block 2330 to block 2340 for encoding the video block using the filtered reconstructed video block.

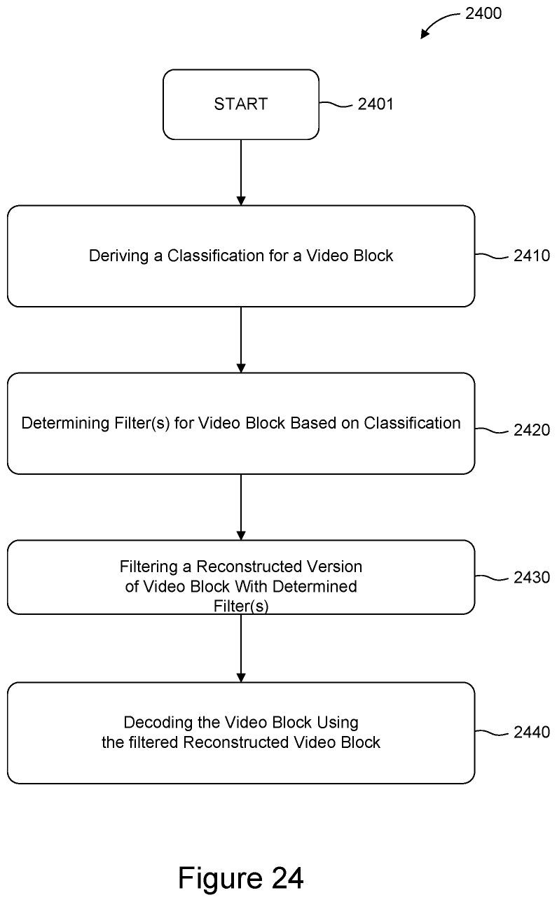

One embodiment of a method 2400 under the general aspects described here is shown in FIG. 24. The method commences at start block 2401 and control proceeds to block 2410 for deriving a classification for a video block. Control proceeds from block 2410 to block 2420 for determining at least one in-loop filter for the video block based on the classification. Control proceeds from block 2420 to block 2430 for filtering a reconstructed version of said video block with said determined at least one in-loop filter. Control proceeds from block 2430 to block 2440 for decoding the video block using the filtered reconstructed video block.

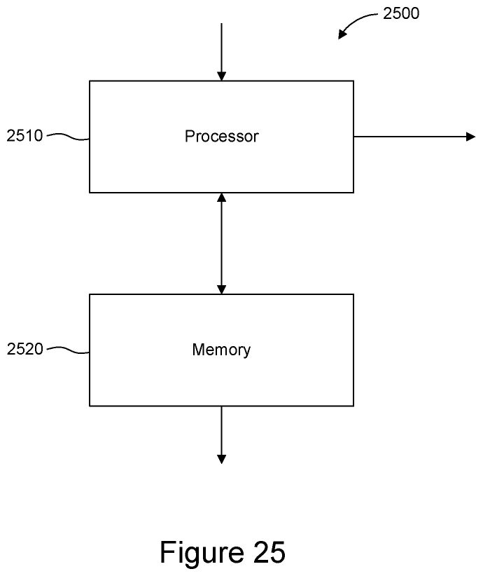

FIG. 25 shows one embodiment of an apparatus 2500 for encoding, decoding, compressing, or decompressing video data using any of the above methods, or variations. The apparatus comprises Processor 2510 and can be interconnected to a memory 2520 through at least one port. Both Processor 2510 and memory 2520 can also have one or more additional interconnections to external connections.

Processor 2510 is also configured to either insert or receive information in a bitstream and, either compressing, encoding, or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 26, 27, and 28 provide some embodiments, but other embodiments are contemplated and the discussion of FIGS. 26, 27, and 28 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the intra prediction, entropy coding, and/or decoding modules (160, 360, 145, 330), of a video encoder 100 and decoder 200 as shown in FIG. 26 and FIG. 27. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 26 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset)/ALF (Adaptive Loop Filtering) filtering to reduce encoding artifacts. The filtered image is stored at a reference picture buffer (180).

FIG. 27 illustrates a block diagram of a video decoder 200. In the decoder 200, a bitstream is decoded by the decoder elements as described below. Video decoder 200 generally performs a decoding pass reciprocal to the encoding pass as described in FIG. 26. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

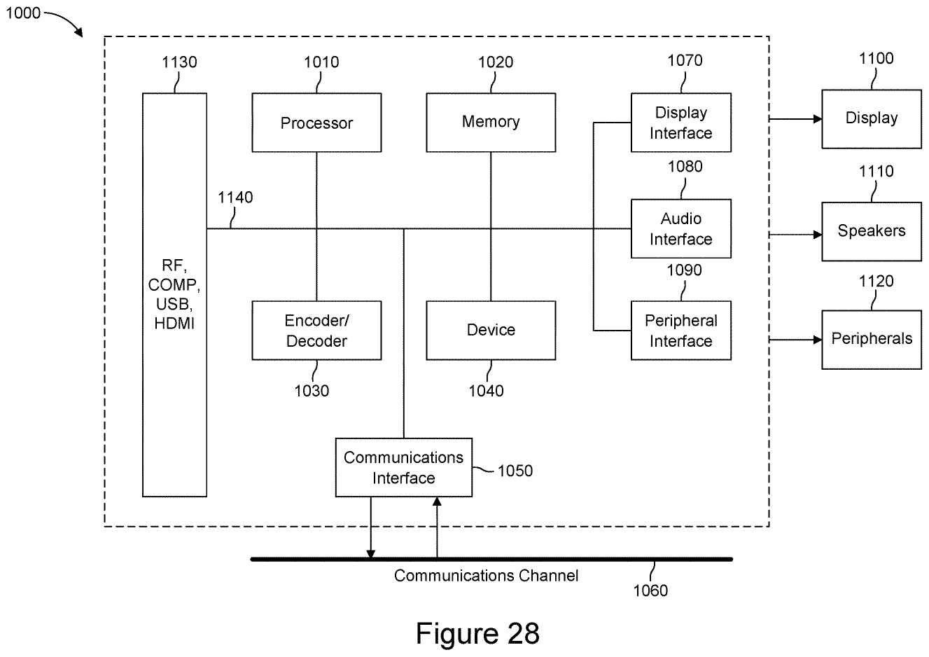

FIG. 28 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components.

For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 28, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

One embodiment comprises an apparatus or method of determining a filter to be used as an in-loop filter in an encoding or decoding video environment.

One embodiment comprises the above embodiment, wherein the filter is either a deblocking filter or an adaptive loop filter.

One embodiment comprises the above method wherein a classification is used to determine the in-loop filter.

One embodiment comprises the above method wherein filter selection is controllable at the coding tree unit level or higher.

Some embodiments comprise any of the above methods wherein an index is signaled to indicate the determined filter.

Some embodiments comprise any of the above methods wherein class merging of filters having the same exact shape and coefficient location occurs.

Some embodiments comprise any of the above methods wherein at least one filter is pre-learned offline and hard coded within an encoder and decoder.

Some embodiments comprise any of the above methods wherein deblock filtering is turned off in one direction.

Some embodiments comprise any of the above methods wherein deblocking filter sets are signaled at a picture, slice or file level or in a parameter set.

Some embodiments comprise any of the above methods wherein at least one filter is selected to be used per classification type.

Some embodiments comprise any of the above methods wherein Wiener filtering is used.

One embodiment comprises a bitstream or signal that includes one or more syntax elements to perform the above functions, or variations thereof.

One embodiment comprises a bitstream or signal that includes syntax conveying information generated according to any of the embodiments described.

One embodiment comprises creating and/or transmitting and/or receiving and/or decoding according to any of the embodiments described.

One embodiment comprises a method, process, apparatus, medium storing instructions, medium storing data, or signal according to any of the embodiments described.

One embodiment comprises inserting in the signaling syntax elements that enable the decoder to determine decoding information in a manner corresponding to that used by an encoder.

One embodiment comprises creating and/or transmitting and/or receiving and/or decoding a bitstream or signal that includes one or more of the described syntax elements, or variations thereof.

One embodiment comprises a TV, set-top box, cell phone, tablet, or other electronic device that performs transform method(s) according to any of the embodiments described.

One embodiment comprises a TV, set-top box, cell phone, tablet, or other electronic device that performs transform method(s) determination according to any of the embodiments described, and that displays (e.g., using a monitor, screen, or other type of display) a resulting image.

One embodiment comprises a TV, set-top box, cell phone, tablet, or other electronic device that selects, bandlimits, or tunes (e.g., using a tuner) a channel to receive a signal including an encoded image, and performs transform method(s) according to any of the embodiments described.

One embodiment comprises a TV, set-top box, cell phone, tablet, or other electronic device that receives (e.g., using an antenna) a signal over the air that includes an encoded image, and performs transform method(s).

1. A method, comprising:
determining at least one in-loop filter for a video block based on a classification;
filtering a reconstructed version of said video block with said determined at least one in-loop filter;
signaling said determined at least one in-loop filter; and,
encoding the video block using the filtered reconstructed video block.

2. An apparatus, comprising
a memory and
a processor, configured to perform:
determining at least one in-loop filter for a video block based on a classification;
filtering a reconstructed version of said video block with said determined at least one in-loop filter;
signaling said determined at least one in-loop filter; and,
encoding the video block using the filtered reconstructed video block.

3. A method, comprising:
deriving a classification for a video block;
determining at least one in-loop filter for the video block based on the classification;
filtering a reconstructed version of said video block with said determined at least one in-loop filter;
decoding the video block using the filtered reconstructed video block.

4. An apparatus, comprising
a memory and
a processor, configured to perform:
deriving a classification for a video block;
determining at least one in-loop filter for the video block based on the classification;
filtering a reconstructed version of said video block with said determined at least one in-loop filter;
decoding the video block using the filtered reconstructed video block.

5. The method of claim 1, wherein encoding of the video block further comprises information indicative of the classification.

6. The apparatus of claim 2, herein decoding of the video block further comprises parsing data to be decoded for information indicative of the classification.

7. The method of claim 1, wherein the at least one in-loop filter is pre-learned.

8. The method of claim 1, wherein the at least one filter is controlled at least on a coding unit level.

9. The apparatus of claim 2, wherein samples of the video block can selectively be filtered.

10. The apparatus of claim 2, wherein said classification depends on spatial distance to the video block boundary or on signal features across block boundaries.

11. The method of claim 1, wherein filter shape or dimensionality depend on location of the sample being filtered.

12. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of claim 1, for playback using a processor.

14. (canceled)

15. A computer program product comprising instructions which, when the program is executed by a computer, cause the computer to carry out the method of claim 3.

16. The apparatus of claim 4, wherein decoding of the video block further comprises parsing data to be decoded for information indicative of the classification.

17. The apparatus of claim 4, wherein the at least one in-loop filter is pre-learned.

18. The apparatus of claim 4, wherein the at least one filter is controlled at least on a coding unit level.

19. The method claim 3, wherein samples of the video block can selectively be filtered.

20. The method of claim 3, wherein said classification depends on spatial distance to the video block boundary or on signal features across block boundaries.

21. The method of claim 3, wherein filter shape or dimensionality depend on location of the sample being filtered.
